(19) United States
(12) Patent Application Publication
(10) Pub. No.: US 2012/0075436 A1
(43) Pub. Date: Mar. 29, 2012

(54) CODING STEREO VIDEO DATA

(75) Inventors: YING CHEN, SAN DIEGO, CA (US); HONGQIANG WANG, SAN MARCOS, CA (US); MARTA KARCZEWICZ, SAN DIEGO, CA (US)

(73) Assignee: QUALCOMM INCORPORATED, San Diego, CA (US)

(21) Appl. No.: 13/194,656

(22) Filed: Jul. 29, 2011

Related U.S. Application Data
(60) Provisional application No. 61/480,336, filed on Apr. 28, 2011.
(60) Provisional application No. 61/386,463, filed on Sep. 24, 2010.

(51) Int. Cl. H04N 7/26; H04N 13/02

(52) U.S. Cl. 348/51; 348/E13.075; 375/E07.027

(57) ABSTRACT

In one example, a method of decoding video data comprising base layer data having a first resolution and enhancement layer data having the first resolution includes decoding the base layer data, wherein the base layer data comprises a reduced resolution version of a left view relative to the first resolution and a reduced resolution version of a right view relative to the first resolution. The method also includes decoding enhancement layer data comprising enhancement data for exactly one of the left view and the right view, wherein the enhancement data has the first resolution, and wherein decoding the enhancement layer data comprises decoding the enhancement layer data relative to at least a portion of the base layer data.

This application claims the benefit of U.S. Provisional Application No. 61/480,336, filed Apr. 28, 2011 and U.S. Provisional Application No. 61/386,463, filed Sep. 24, 2010, each of which is hereby incorporated by reference in its entirety.

### TECHNICAL FIELD

This disclosure relates to video coding, and more particularly, to coding of stereo video data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice are encoded using spatial prediction with respect to neighboring macroblocks. Macroblocks in an inter-coded (P or B) frame or slice may use spatial prediction with respect to neighboring macroblocks in the same frame or slice or temporal prediction with respect to other reference frames.

Efforts have been made to develop new video coding standards based on H.264/AVC. One such standard is the scalable video coding (SVC) standard, which is the scalable extension to H.264/AVC. Another standard is the multi-view video coding (MVC), which has become the multiview extension to H.264/AVC. A joint draft of MVC is in described in JVT-AB204, “Joint Draft 8.0 on Multiview Video Coding,” 28^{th} JVT meeting, Hannover, Germany, July 2008, available at http://wftp3.itu.int/av-arch/jvt-site/2008_{—}07_Hannover/JVT-AB204.zip. A version of the AVC standard is described in JVT-AD007, “Editors' draft revision to ITU-T Rec. H.264|ISO/IEC 14496-10 Advanced Video Coding—in preparation for ITU-T SG 16 AAP Consent (in integrated form),” 30th JVT meeting, Geneva, CH, February 2009,” available from http://wftp3.itu.int/av-arch/jvt-site/2009_{—}01_Geneva/JVT-AD007.zip. The JVT-AD007 document integrates SVC and MVC in the AVC specification.

### SUMMARY

In general, this disclosure describes techniques for supporting stereo video data, e.g., video data used to produce a three-dimensional (3D) effect. To produce a three-dimensional effect in video, two views of a scene, e.g., a left eye view and a right eye view, may be shown simultaneously or nearly simultaneously. The techniques of this disclosure include forming a scalable bitstream having a base layer and one or more enhancement layers. For example, techniques of this disclosure include forming a base layer that includes individual frames, each having data for two reduced resolution views of a scene. That is, a frame of the base layer includes data for two images from slightly different horizontal perspectives of the scene. Thus, frames of the base layer may be referred to as packed frames. In addition to the base layer, the techniques of this disclosure include forming one or more enhancement layers that correspond to full resolution representations of one or more views of the base layer. The enhancement layers may be inter-layer predicted, e.g., relative to the video data for the same view of the base layer, and/or inter-view predicted, e.g., relative to the video data for another view of the base layer forming a stereo view pair with the view of the enhancement layer or relative to video data of a different enhancement layer. At least one of the enhancement layers contains only the coded signal of one of the stereo views.

In one example, a method of decoding video data comprising base layer data and enhancement layer data includes decoding base layer data having a first resolution, wherein the base layer data comprises a reduced resolution version of a left view relative to the first resolution and a reduced resolution version of a right view relative to the first resolution. The method also includes decoding enhancement layer data having the first resolution and comprising enhancement data for exactly one of the left view and the right view, wherein the enhancement data has the first resolution, and wherein decoding the enhancement layer data comprises decoding the enhancement layer data relative to at least a portion of the base layer data. The method also includes combining the decoded enhancement layer data with the one of the left view or the right view of the decoded base layer data to which the decoded enhancement layer corresponds.

In another example, an apparatus for decoding video data comprising base layer data and enhancement layer data includes a video decoder. In this example, the video decoder is configured to decode base layer data having a first resolution, wherein the base layer data comprises a reduced resolution version of a left view relative to the first resolution and a reduced resolution version of a right view relative to the first resolution. The video decoder is also configured to decode enhancement layer data having the first resolution and comprising enhancement data for exactly one of the left view and the right view, wherein the enhancement data has the first resolution, and wherein decoding the enhancement layer data comprises decoding the enhancement layer data relative to at least a portion of the base layer data. The video decoder is also configured to combine the decoded enhancement layer data with the one of the left view or the right view of the decoded base layer data to which the decoded enhancement layer corresponds.

In another example, an apparatus for decoding video data comprising base layer data and enhancement layer data includes a means for decoding base layer data having a first resolution, wherein the base layer data comprises a reduced resolution version of a left view relative to the first resolution and a reduced resolution version of a right view relative to the first resolution. The apparatus also includes a means for decoding enhancement layer data having the first resolution and comprising enhancement data for exactly one of the left view and the right view, wherein the enhancement data has the first resolution, and wherein decoding the enhancement layer data comprises decoding the enhancement layer data relative to at least a portion of the base layer data. The apparatus also includes a means for combining the decoded enhancement layer data with the one of the left view or the right view of the decoded base layer data to which the decoded enhancement layer corresponds.

In another example, a computer program product comprising a computer-readable storage medium having stored thereon instructions that, when executed, cause a processor of a device for decoding video data having base layer data and enhancement layer data to decode base layer data having a first resolution, wherein the base layer data comprises a reduced resolution version of a left view relative to the first resolution and a reduced resolution version of a right view relative to the first resolution. The instructions also cause the processor to decode enhancement layer data having the first resolution and comprising enhancement data for exactly one of the left view and the right view, wherein the enhancement data has the first resolution, and wherein decoding the enhancement layer data comprises decoding the enhancement layer data relative to at least a portion of the base layer data. The instructions also cause the processor to combine the decoded enhancement layer data with the one of the left view or the right view of the decoded base layer data to which the decoded enhancement layer corresponds.

In another example, a method of encoding video data comprising base layer data and enhancement layer data includes encoding base layer data having a first resolution, wherein the base layer data comprises a reduced resolution version of a left view relative to the first resolution and a reduced resolution version of a right view relative to the first resolution. The method also includes encoding enhancement layer data having a first resolution and comprising enhancement data for exactly one of the left view and the right view, wherein the enhancement data has the first resolution, and wherein decoding the enhancement layer data comprises decoding the enhancement layer data relative to at least a portion of the base layer data.

In another example, an apparatus for encoding video data comprising a left view of a scene and a right view of the scene, wherein the left view has a first resolution and the right view has the first resolution, includes a video encoder. In this example, the video encoder is configured to encode base layer data comprising a reduced resolution version of the left view relative to the first resolution and the reduced resolution version of the right view relative to the first resolution. The video encoder is also configured to encode enhancement layer data comprising enhancement data for exactly one of the left view and the right view, wherein the enhancement data has the first resolution. The video encoder is also configured to output the base layer data and the enhancement layer data.

In another example, an apparatus for encoding video data comprising a left view of a scene and a right view of the scene, wherein the left view has a first resolution and the right view has the first resolution, includes a means for encoding base layer data comprising a reduced resolution version of the left view relative to the first resolution and the reduced resolution version of the right view relative to the first resolution. The apparatus also includes a means for encoding enhancement layer data comprising enhancement data for exactly one of the left view and the right view, wherein the enhancement data has the first resolution. The apparatus also includes a means for outputting the base layer data and the enhancement layer data.

In another example, a computer program product comprising a computer-readable storage medium having stored thereon instructions that, when executed, cause a processor of a device for encoding video data to receive video data comprising a left view of a scene and a right view of the scene, wherein the left view has a first resolution and the right view has the first resolution. The instructions also cause the processor to encode base layer data comprising a reduced resolution version of the left view relative to the first resolution and the reduced resolution version of the right view relative to the first resolution. The instructions also cause the processor to encode enhancement layer data comprising enhancement data for exactly one of the left view and the right view, wherein the enhancement data has the first resolution. The instructions also cause the processor to output the base layer data and the enhancement layer data.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize techniques for forming a scalable multi-view bitstream including pictures from two views of a scene.

FIG. 2A is a block diagram illustrating an example of video encoder that may implement techniques for producing a scalable multi-view bitstream having a base layer that includes two reduced resolution pictures and two additional enhancement layers that each include a respective full resolution picture from the base layer.

FIG. 2B is a block diagram illustrating another example of a video encoder that may implement techniques for producing a scalable multi-view bitstream having a base layer that includes two reduced resolution pictures and two additional enhancement layers that each includes a respective full resolution picture corresponding to the base layer.

FIG. 3 is a block diagram illustrating an example of video decoder, which decodes an encoded video sequence.

FIG. 4 is a conceptual diagram illustrating a left eye view picture and a right eye view picture combined by a video encoder to form a base layer having reduced resolution pictures for both views, as well as a full resolution enhancement layer of the left eye view picture.

FIG. 5 is a conceptual diagram illustrating a left eye view picture and a right eye view picture combined by a video encoder to form a base layer having reduced resolution pictures for both views, as well as a full resolution enhancement layer of the right eye view picture.

FIG. 6 is a conceptual diagram illustrating a left eye view picture and a right eye view picture combined by a video encoder to form a base layer, a full resolution left eye view picture, and a full resolution right eye view picture.

FIG. 7 is a flowchart illustrating an example method for forming and encoding a scalable multi-view bitstream that includes a base layer having two reduced resolution pictures of two different views, as well as a first enhancement layer and a second enhancement layer.

FIG. 8 is a flowchart illustrating an example method for decoding a scalable multi-view bitstream having a base layer, a first enhancement layer, and a second enhancement layer.

### DETAILED DESCRIPTION

In general, this disclosure relates to techniques for supporting stereo video data, e.g., video data used to produce a three-dimensional visual effect. To produce a three-dimensional visual effect in video, two views of a scene, e.g., a left eye view and a right eye view, are shown simultaneously or nearly simultaneously. Two pictures of the same scene, corresponding to the left eye view and the right eye view of the scene, may be captured from slightly different horizontal positions, representing the horizontal disparity between a viewer's left and right eyes. By displaying these two pictures simultaneously or nearly simultaneously, such that the left eye view picture is perceived by the viewer's left eye and the right eye view picture is perceived by the viewer's right eye, the viewer may experience a three-dimensional video effect.

This disclosure provides techniques for forming a scalable multi-view bitstream including a base layer having a plurality of packed frames and one or more full resolution enhancement layers. Each of the packed frames of the base layer may correspond to a single frame of video data having data for two pictures corresponding to different views of a scene (e.g., a “right eye view” and a “left eye view”). In particular, the techniques of this disclosure may include encoding a base layer having a reduced resolution picture of a left eye view of a scene and a reduced resolution picture of a right eye view of the scene that are packed into one frame and encoded. In addition, the techniques of this disclosure include encoding two full resolution enhancement layers, each including one view of the stereo pair included in the base layer, in a scalable manner. For example, in addition to the base layer, the techniques of this disclosure may include encoding a first enhancement layer having a full resolution picture of either the right eye view or the left eye view. Techniques of this disclosure may also include encoding a second enhancement layer having a full resolution picture of the other respective view (e.g., either the right eye view or the left eye view that is not included in the first enhancement layer). According to some aspects of the disclosure, the multi-view bitstream may be coded in a scalable way. That is, a device receiving the scalable multi-view bitstream may receive and utilize the base layer only, the base layer and one enhancement layer, or the base layer and both enhancement layers.

In some examples, the techniques of this disclosure may be directed to the use of asymmetric packed frames. That is, in some examples, the base layer may be combined with one enhancement layer to produce a full resolution picture for one view, which is coded in the enhancement layer and a reduced resolution picture for the other view, which is coded as part of the base layer. Without loss of generality, assume that the full resolution picture (e.g., from the first enhancement layer) is the right eye view and the reduced resolution picture is the left eye view portion of the base layer. In this manner, a destination device may upsample the left eye view to provide three-dimensional output. Again, in this example, the enhancement layer may be inter-layer predicted (e.g., relative to the data for the left eye view in the base layer) and/or inter-view predicted (e.g., relative to the data for the right eye view in the base layer).

This disclosure generally refers to a picture as a sample of a view. This disclosure generally refers to a frame as comprising one or more pictures, which is to be coded as at least a portion of an access unit representing a specific time instance. Accordingly, a frame may correspond to a sample of a view (that is, a single picture) or, in the case of packed frames, include samples from multiple views (that is, two or more pictures).

In addition, this disclosure generally refers to a “layer” that may include a series of frames having similar characteristics. According to aspects of the disclosure, a “base layer” may include a series of packed frames (e.g., a frame that includes data for two views at a single temporal instance), and each picture of each view included in the packed frame may be encoded at a reduced resolution (e.g., half resolution). According aspects of the disclosure, an “enhancement layer” may include data for one of the views of the base layer that can be used to reproduce a full resolution picture for the view at a relatively higher quality (e.g., with reduced distortion) relative to decoding the data at the base layer alone. According to some examples, as noted above, a full resolution picture of one view (of an enhancement layer) and a reduced resolution picture from the other view of the base layer may be combined to form an asymmetric representation of a stereo scene.

According to some examples, a base layer may be compliant with H.264/AVC, which allows two pictures to be subsampled and packed into a single frame for coding. In addition, enhancement layers may be coded with respect to the base layer and/or with respect to another enhancement layer. In an example, the base layer may contain a half resolution first picture (e.g., “left eye view”) and a half resolution second picture (e.g., “right eye view”) that are packed into a single frame in a particular frame packing arrangement, e.g., top-bottom, side-by-side, interleaved row, interleaved column, quincunx (e.g., “checkerboard”), or other manner. In addition, a first enhancement layer may include a full resolution picture that corresponds to one of the pictures included in the base layer, while a second enhancement layer may include another full resolution picture that corresponds to the other respective picture included in the based layer.

In an example, the first enhancement layer may correspond to the first view (e.g., the left eye view) of the base layer, while the second enhancement layer may correspond to the second view (e.g., the right eye view) of the base layer. In this example, the first enhancement layer may include full resolution frames that are inter-layer predicted from the left eye view of the base layer, and/or that are inter-view predicted from the right eye view of the base layer. Moreover, a second enhancement layer may include full resolution frames that are inter-layer predicated from the right eye view of the base layer, and/or that are inter-view predicted from the left eye view of the base layer. Additionally or alternatively, the second enhancement layer may include full resolution frames that are inter-view predicted from the first enhancement layer.

In another example, the first enhancement layer may correspond to the second view (e.g., the right eye view) of the base layer, while the second enhancement layer may correspond to the first view (e.g., the left eye view) of the base layer. In this example, the first enhancement layer may include full resolution frames that are inter-layer predicted from the right eye view of the base layer, and/or that are inter-view predicted from the left eye view of the base layer. Moreover, a second enhancement layer may include full resolution frames that are inter-layer predicated from the left eye view of the base layer, and/or that are inter-view predicted from the right eye view of the base layer. Additionally or alternatively, the second enhancement layer may include a full resolution frames that are inter-view predicted from the first enhancement layer.

Techniques of this disclosure include coding data in accordance with a scalable coding format that allows a receiving device, such as a client device having a decoder, to receive and utilize the base layer, the base layer and an enhancement layer, or the base layer and two enhancement layers. For example, various client devices may be capable of utilizing different operation points of the same representation.

In particular, in an example in which an operation point corresponds to only the base layer, and a client device is capable of two-dimensional (2D) display, the client device may decode the base layer and discard the pictures associated with one of the views of the base layer. That is, for example, the client device may display the pictures associated with one view of the base layer (e.g., the left eye view) and discard the pictures associated with the other view of the base layer (e.g., the right eye view).

In another example in which an operation point includes the base layer, and a client device is capable of stereo or three-dimensional (3D) display, the client device may decode the base layer and display pictures of both views associated with the base layer. That is, the client device may receive the base layer and, in accordance with the techniques of this disclosure, reconstruct pictures of the left eye view and right eye view for display. The client device may upsample the pictures of the left eye view and right eye view of the base layer before displaying the pictures.

In another example, an operation point may include the base layer and one enhancement layer. In this example, a client device having a 2D “high definition” (HD) display capability may receive the base layer and one enhancement layer and, in accordance with techniques of this disclosure, reconstruct pictures of only the full-resolution view from the enhancement layer. As used herein, “high definition” may refer to a native resolution of 1920×1080 pixels, although it should be understood that what constitutes “high definition” is relative, and other resolutions may also be considered “high definition.”

In another example in which the operation point includes the base layer and one enhancement layer, and a client device has stereo display capability, the client device may decode and reconstruct pictures of the full-resolution view of the enhancement layer, as well as the half resolution pictures of the opposite view of the base layer. The client device may then upsample the half resolution pictures of the base layer prior to display.

In still another example, an operation point may include the base layer and two enhancement layers. In this example, a client device may receive the base layer and two enhancement layers and, in accordance with techniques of this disclosure, reconstruct pictures of the left eye view and right eye view for 3D HD display. Thus, the client device may utilize the enhancement layers to provide full resolution data related to both views. Accordingly, the client device may display native full resolution pictures of both views.

The scalable nature of the techniques of this disclosure allows various client devices to take advantage of the base layer, the base layer and one enhancement layer, or the base layer and both enhancement layers. According to some aspects, a client device that is capable of displaying a single view may utilize video data that provides a single view reconstruction. For example, such a device may receive the base layer, or the base layer and one enhancement layer to provide a single view representation. In this example, the client device may avoid requesting, or discard upon receiving, enhancement layer data associated with another view. When the device does not receive or decode enhancement layer data of a second view, the device may upsample pictures from one view of the base layer.

According to other aspects, a client device that is capable of displaying more than one view (e.g., a three-dimensional television, computer, handheld device, or the like) may utilize data from the base layer, the first enhancement layer, and/or the second enhancement layer. For example, such a device may utilize data from the base layer to produce a three dimensional representation of a scene using both views of the base layer in a first resolution. Alternatively, such a device may utilize data from the base layer and one enhancement layer to produce a three dimensional representation of a scene, with one of the views of the scene having a relatively higher resolution than the other view of the scene. Alternatively, such a device may utilize data from the base layer and both enhancement layers to produce a three dimensional representation of a scene, with both views having a relatively high resolution.

In this manner, a representation of multimedia content may include three layers: a base layer having video data for two views (e.g., a left and a right view), a first enhancement layer for one of the two views, and a second enhancement layer for the other of the two views. As discussed above, the two views may form a stereo view pair, in that the data of the two views may be displayed to produce a three-dimensional effect. In accordance with the techniques of this disclosure, the first enhancement layer may be predicted from either or both of the corresponding view coded in the base layer and/or an opposite view coded in the base layer. The second enhancement layer may be predicted from either or both of the corresponding view coded in the base layer and/or the first enhancement layer. This disclosure refers to prediction of an enhancement layer from a corresponding view of a base layer as “inter-layer prediction” and prediction of an enhancement layer from an opposite view (whether from the base layer or another enhancement layer) as “inter-view prediction.” Either or both of the enhancement layers may be inter-layer predicted and/or inter-view predicted.

This disclosure also provides techniques for signaling layer dependencies at the network abstraction layer (NAL), e.g., in supplemental enhancement information (SEI) messages of NAL units, or sequence parameter set (SPS). This disclosure also provides techniques for signaling decoding dependency of NAL units in an access unit (of the same time instance). That is, this disclosure provides techniques for signaling how a particular NAL unit is used to predict other layers of the scalable multi-view bitstream. In the example of H.264/AVC (Advanced Video Coding), coded video segments are organized into NAL units, which provide a “network-friendly” video representation addressing applications such as video telephony, storage, broadcast, or streaming NAL units can be categorized as Video Coding Layer (VCL) NAL units and non-VCL NAL units. VCL units may contain output from the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

In some examples, the techniques of this disclosure may be applied to H.264/AVC codecs or codecs based on advanced video coding (AVC), such as scalable video encoding (SVC), multiview video coding (MVC), or other extensions of H.264/AVC. Such codecs may be configured to recognize SEI messages when the SEI messages are associated with an access unit, where the SEI message may be encapsulated within the access unit in an ISO base media file format or MPEG-2 Systems bitstream. The techniques may also be applied to future coding standards, e.g., H.265/HEVC (high efficiency video coding).

SEI messages may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of SVC and view scalability information SEI messages in MVC. These example SEI messages may convey information on, e.g., extraction of operation points and characteristics of the operation points.

H.264/AVC provides a frame packing SEI message, which is a codec-level message indicating a frame packing type for a frame including a two pictures, e.g., a left view and a right view of a scene. For example, various types of frame packing methods are supported for spatial interleaving of two frames. The supported interleaving methods include checkerboard, column interleaving, row interleaving, side-by-side, top-bottom, and side-by-side with checkerboard upconversion. The frame packing SEI message is described in “Information technology—Coding of audio-visual objects—Part 10: Advanced Video Coding, AMENDMENT 1: Constrained baseline profile, stereo high profile and frame packing arrangement SEI message,” N101303, MPEG of ISO/IEC JTC1/SC29/WG11, Xian, China, October 2009, which is incorporated into the most recent version of the H.264/AVC standard. In this manner, H.264/AVC supports interleaving of two pictures of left view and right view into one picture and coding such pictures into a video sequence.

This disclosure provides an operation point SEI message that indicates the operation points available for the encoded video data. For example, this disclosure provides an operation point SEI message that indicates operation points for various reduced resolution and full resolution layer combinations. Such combinations may be further categorized based on different temporal subsets, corresponding to different frame rates. A decoder may use this information to determine whether a bitstream includes multiple layers, and to properly separate the base layer into constituent pictures of the two views and enhancement views.

In addition, according to some aspects of the disclosure, the techniques of this disclosure include providing a sequence parameter set (“SPS”) extension for H.264/AVC. For example, a sequence parameter set may contain information that may be used to decode a relatively large number of VCL NAL units. A sequence parameter set may apply to a series of consecutively coded pictures called a coded video sequence. According to some examples, the techniques of the disclosure may relate to providing an SPS extension to describe (1) the location of the pictures of the left eye view in the base layer, (2) the order of the full resolution enhancement layers (e.g., whether the pictures of the left eye view are encoded before the pictures of the right eye view, or vice versa), (3) the dependency of the full resolution enhancement layers (e.g., whether the enhancement layers are predicted from the base layer or another enhancement layer), (4) the support of operation points for full resolution of a single view picture (e.g., support for one of the pictures of the base layer and one corresponding enhancement layer), (5) the support of asymmetric operation points (e.g., support for the base layer including frames having a full resolution picture for one view and a reduced resolution picture for the other view) (6) the support of inter-layer prediction, and (7) the support of inter-view prediction.

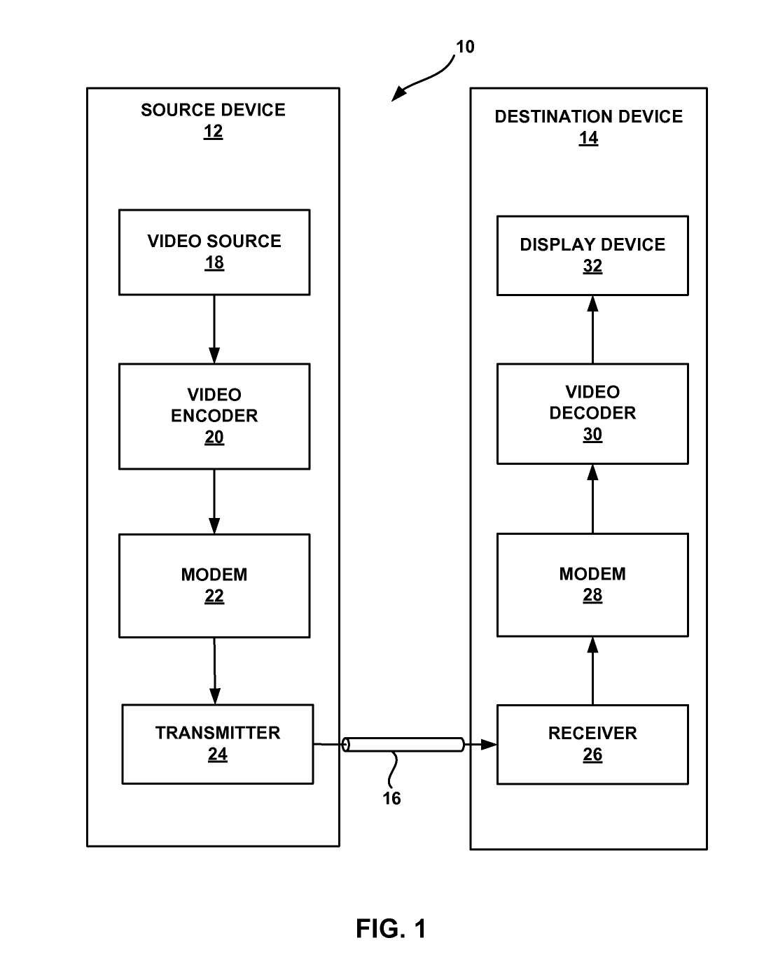

FIG. 1 is a block diagram illustrating an example video encoding and decoding system that may utilize techniques for forming a scalable multi-view bitstream including pictures from two views of a scene. As shown in FIG. 1, system 10 includes a source device 12 that transmits encoded video to a destination device 14 via a communication channel 16. Source device 12 and destination device 14 may comprise any of a wide range of devices, such as fixed or mobile computing devices, set-top boxes, gaming consoles, digital media players, or the like. In some cases, source device 12 and destination device 14 may comprise wireless communication devices, such as wireless handsets, so-called cellular or satellite radiotelephones, or any wireless devices that can communicate video information over a communication channel 16, in which case communication channel 16 is wireless.

The techniques of this disclosure, however, which concern forming a scalable multi-view bitstream, are not necessarily limited to wireless applications or settings. For example, these techniques may apply to over-the-air television broadcasts, cable television transmissions, satellite television transmissions, Internet video transmissions, encoded digital video that is encoded onto a storage medium, or other scenarios. Accordingly, communication channel 16 may comprise any combination of wireless or wired media suitable for transmission of encoded video data.

In the example of FIG. 1, source device 12 includes a video source 18, video encoder 20, a modulator/demodulator (modem) 22 and a transmitter 24. Destination device 14 includes a receiver 26, a modem 28, a video decoder 30, and a display device 32. In accordance with this disclosure, video encoder 20 of source device 12 may be configured to apply the techniques for forming a scalable multi-view bitstream, e.g., a base layer and one or more enhancement layers (e.g., two enhancement layers). For example, the base layer may include coded data for two pictures, each from a different view of a scene (e.g., a left eye view and a right eye view), where the video encoder 20 reduces the resolution of both pictures and combines the pictures into a single frame (e.g., each picture is one-half of the resolution of the full resolution frame). A first enhancement layer may include coded data for a full resolution representation of one of the views of the base layer, while a second enhancement later may include coded data for a full resolution for the other respective view of the base layer.

In particular, video encoder 20 may implement inter-view prediction and/or inter-layer prediction to encode the enhancement layers relative to the base layer. Suppose, for example, video encoder 20 is encoding an enhancement layer that corresponds to pictures of the left eye view of the base layer. In this example, video encoder 20 may implement an inter-layer prediction scheme to predict the enhancement layer from the corresponding pictures of the left eye view of the base layer. In some examples, video encoder 20 may reconstruct pictures of the left eye view of the base layer prior to predicting pictures of the enhancement layer. For example, video encoder 20 may upsample pictures of left eye view of the base layer before predicting pictures of the enhancement layer. Video encoder 20 may perform inter-layer prediction by performing inter-layer texture prediction based on the reconstructed base layer, or by performing inter-layer motion prediction based on the motion vectors of the base layer. Additionally or alternatively, video encoder 20 may implement an inter-view prediction scheme to predict the enhancement layer from the pictures of the right eye view of the base layer. In this example, video encoder 20 may reconstruct full resolution pictures of the right eye view of the base layer prior to performing inter-view prediction for the enhancement layer.

In addition to the enhancement layer that corresponds to the full resolution pictures of the left eye view of the base layer, video encoder 20 may also encode another enhancement layer that corresponds to full resolution pictures of a right eye view of the base layer. According to some aspects of the disclosure, video encoder 20 may predict the enhancement layer pictures of the right eye view using inter-view prediction and/or inter-layer prediction with respect to the base layer. In addition, video encoder 20 may predict the enhancement layer pictures of the right eye view using inter-view prediction with respect to the other, previously generated enhancement layer (e.g., the enhancement layer that corresponds with the left eye view).

In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Techniques for producing a scalable multi-view bitstream may be performed by any digital video encoding and/or decoding device. Although generally the techniques of this disclosure are performed by a video encoding device, the techniques may also be performed by a video encoder/decoder, typically referred to as a “CODEC.” Moreover, aspects of the techniques of this disclosure may also be performed by a video preprocessor or video postprocessor, such as a file encapsulation unit, file decapsulation unit, video multiplexer, or video demultiplexer. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between devices 12, 14, e.g., for video streaming, video playback, video broadcasting, video gaming, or video telephony.

Video source 18 of source device 12 may include a video capture device, such as a video camera, a video archive containing previously captured video, and/or a video feed from a video content provider. As a further alternative, video source 18 may generate computer graphics-based data as the source video, or a combination of live video, archived video, and computer generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications executed by mobile or generally non-mobile computing devices. In any case, the captured, pre-captured, or computer-generated video may be encoded by video encoder 20.

Video source 18 may provide pictures from two or more views to video encoder 20. Two pictures of the same scene may be captured simultaneously or nearly simultaneously from slightly different horizontal positions, such that the two pictures can be used to produce a three-dimensional effect. Alternatively, video source 18 (or another unit of source device 12) may use depth information or disparity information to generate a second picture of a second view from a first picture of a first view. The depth or disparity information may be determined by a camera capturing the first view, or may be calculated from data in the first view.

MPEG-C part-3 provides a specified format for including a depth map for a picture in a video stream. The specification is described in “Text of ISO/IEC FDIS 23002-3 Representation of Auxiliary Video and Supplemental Information,” ISO/IEC JTC 1/SC 29/WG 11, MPEG Doc, N81368, Marrakech, Morocoo, January 2007. In MPEG-C part 3, auxiliary video can be a depth map or a parallax map. When representing a depth map, MPEG-C part-3 may provide flexibilities, in terms of number of bits used to represent each depth value and resolution of depth map. For example, the map may be one-quarter of the width and one-half of the height of the image described by the map. The map may be coded as a monochromatic video sample, e.g., within an H.264/AVC bitstream with only the luminance component. Alternatively, the map may be coded as auxiliary video data, as defined in H.264/AVC. In the context of this disclosure, a depth map or a parallax map may have the same resolution as the primary video data. Although the H.264/AVC specification does not currently specify the usage of auxiliary video data to code depth map the techniques of this disclosure may be used in conjunction with techniques for using such a depth map or parallax map.

The encoded video information may then be modulated by modem 22 according to a communication standard, and transmitted to destination device 14 via transmitter 24. Modem 22 may include various mixers, filters, amplifiers or other components designed for signal modulation. Transmitter 24 may include circuits designed for transmitting data, including amplifiers, filters, and one or more antennas.

Receiver 26 of destination device 14 receives information over channel 16, and modem 28 demodulates the information. Again, the video encoding process may implement one or more of the techniques described herein to provide a scalable multi-view bitstream. That is, the video encoding process may implement one or more of the techniques described here to provide a bitstream having a base layer that includes reduced resolution pictures of two views, as well as two enhancement layers that include corresponding full resolution pictures of the views of the base layer.

The information communicated over channel 16 may include syntax information defined by video encoder 20, which is also used by video decoder 30, that includes syntax elements that describe characteristics and/or processing of macroblocks and other coded units, e.g., GOPs. Accordingly, video decoder 30 may unpack the base layer into constituent pictures of the views, decode the pictures, and upsample the reduced resolution pictures to the full resolution. Video decoder 30 may also determine the method used to encode the one or more enhancement layers (e.g., the prediction method) and decode the one or more enhancement layers to produce full resolution pictures of one or both views included in the base layer. Display device 32 may display the decoded pictures to a user.

Display device 32 may comprise any of a variety of display devices such as a cathode ray tube (CRT), a liquid crystal display (LCD), a plasma display, an organic light emitting diode (OLED) display, or another type of display device. Display device 32 may display the two pictures from the multi-view bitstream simultaneously or nearly simultaneously. For example, display device 32 may comprise a stereoscopic three-dimensional display device capable of displaying two views simultaneously or nearly simultaneously.

A user may wear active glasses to rapidly and alternatively shutter left and right lenses, such that display device 32 may rapidly switch between the left and the right view in synchronization with the active glasses. Alternatively, display device 32 may display the two views simultaneously, and the user may wear passive glasses (e.g., with polarized lenses) which filter the views to cause the proper views to pass through to the user's eyes. As still another example, display device 32 may comprise an autostereoscopic display, for which no glasses are needed.

In the example of FIG. 1, communication channel 16 may comprise any wireless or wired communication medium, such as a radio frequency (RF) spectrum or one or more physical transmission lines, or any combination of wireless and wired media. Communication channel 16 may form part of a packet-based network, such as a local area network, a wide-area network, or a global network such as the Internet. Communication channel 16 generally represents any suitable communication medium, or collection of different communication media, for transmitting video data from source device 12 to destination device 14, including any suitable combination of wired or wireless media. Communication channel 16 may include routers, switches, base stations, or any other equipment that may be useful to facilitate communication from source device 12 to destination device 14.

Video encoder 20 and video decoder 30 may operate according to a video compression standard, such as the ITU-T H.264 standard, alternatively referred to as MPEG-4, Part 10, Advanced Video Coding (AVC). The techniques of this disclosure, however, are not limited to any particular coding standard. Other examples include MPEG-2 and ITU-T H.263. Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

The ITU-T H.264/MPEG-4 (AVC) standard was formulated by the ITU-T Video Coding Experts Group (VCEG) together with the ISO/IEC Moving Picture Experts Group (MPEG) as the product of a collective partnership known as the Joint Video Team (JVT). In some aspects, the techniques described in this disclosure may be applied to devices that generally conform to the H.264 standard. The H.264 standard is described in ITU-T Recommendation H.264, Advanced Video Coding for generic audiovisual services, by the ITU-T Study Group, and dated March, 2005, which may be referred to herein as the H.264 standard or H.264 specification, or the H.264/AVC standard or specification. The Joint Video Team (JVT) continues to work on extensions to H.264/MPEG-4 AVC.

Techniques of the disclosure may include modified extensions to the H.264/AVC standard. For example, video encoder 20 and video decoder 30 may utilize modified scalable video encoding (SVC), multiview video coding (MVC), or other extensions of H.264/AVC. In an example, techniques of the disclosure include a H.264/AVC extension referred to as “multi-view frame compatible” (“MFC”) that includes a “base view” (e.g., referred to herein as a base layer) and one or more “enhancement views” (e.g., referred to herein as enhancement layers). That is, the “base view” of the MFC extension may include reduced resolution pictures of two views of a scene captured at slightly different horizontal perspectives but nearly simultaneously or nearly simultaneously in time. As such, the “base view” of the MFC extension may actually include pictures from multiple “views” as described herein (e.g., left eye view and right eye view). In addition, an “enhancement view” of the MFC extension may include full resolution pictures of one of the views included in the “base view.” For example, an “enhancement view” of the MFC extension may include full resolution pictures of the left eye view of the “base view.” Another “enhancement view” of the MFC extension may include full resolution pictures of the right eye view of the “base view.”

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. Each of video encoder 20 and video decoder 30 may be included in one or more encoders or decoders, either of which may be integrated as part of a combined encoder/decoder (CODEC) in a respective camera, computer, mobile device, subscriber device, broadcast device, set-top box, server, or the like.

A video sequence typically includes a series of video frames. A group of pictures (GOP) generally comprises a series of one or more video frames. A GOP may include syntax data in a header of the GOP, a header of one or more frames of the GOP, or elsewhere, that describes a number of frames included in the GOP. Each frame may include frame syntax data that describes an encoding mode for the respective frame. Video encoder 20 typically operates on video blocks within individual video frames in order to encode the video data. A video block may correspond to a macroblock or a partition of a macroblock. The video blocks may have fixed or varying sizes, and may differ in size according to a specified coding standard. Each video frame may include a plurality of slices. Each slice may include a plurality of macroblocks, which may be arranged into partitions, also referred to as sub-blocks.

As an example, the ITU-T H.264 standard supports intra prediction in various block sizes, such as 16 by 16, 8 by 8, or 4 by 4 for luma components, and 8×8 for chroma components, as well as inter prediction in various block sizes, such as 16×16, 16×8, 8×16, 8×8, 8×4, 4×8 and 4×4 for luma components and corresponding scaled sizes for chroma components. In this disclosure, “N×N” and “N by N” may be used interchangeably to refer to the pixel dimensions of the block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Block sizes that are less than 16 by 16 may be referred to as partitions of a 16 by 16 macroblock. Video blocks may comprise blocks of pixel data in the pixel domain, or blocks of transform coefficients in the transform domain, e.g., following application of a transform such as a discrete cosine transform (DCT), an integer transform, a wavelet transform, or a conceptually similar transform to residual video block data representing pixel differences between coded video blocks and predictive video blocks. In some cases, a video block may comprise blocks of quantized transform coefficients in the transform domain.

Smaller video blocks can provide better resolution, and may be used for locations of a video frame that include high levels of detail. In general, macroblocks and the various partitions, sometimes referred to as sub-blocks, may be considered video blocks. In addition, a slice may be considered to be a plurality of video blocks, such as macroblocks and/or sub-blocks. Each slice may be an independently decodable unit of a video frame. Alternatively, frames themselves may be decodable units, or other portions of a frame may be defined as decodable units. The term “coded unit” may refer to any independently decodable unit of a video frame such as an entire frame, a slice of a frame, a group of pictures (GOP) also referred to as a sequence, or another independently decodable unit defined according to applicable coding techniques.

Following intra-predictive or inter-predictive coding to produce predictive data and residual data, and following any transforms (such as the 4×4 or 8×8 integer transform used in H.264/AVC or a discrete cosine transform DCT) applied to residual data to produce transform coefficients, quantization of transform coefficients may be performed. Quantization generally refers to a process in which transform coefficients are quantized to possibly reduce the amount of data used to represent the coefficients. The quantization process may reduce the bit depth associated with some or all of the coefficients. For example, an n-bit value may be rounded down to an m-bit value during quantization, where n is greater than m.

Following quantization, entropy coding of the quantized data may be performed, e.g., according to content adaptive variable length coding (CAVLC), context adaptive binary arithmetic coding (CABAC), or another entropy coding methodology. A processing unit configured for entropy coding, or another processing unit, may perform other processing functions, such as zero run length coding of quantized coefficients and/or generation of syntax information such as coded block pattern (CBP) values, macroblock type, coding mode, maximum macroblock size for a coded unit (such as a frame, slice, macroblock, or sequence), or the like.

Video encoder 20 may further send syntax data, such as block-based syntax data, frame-based syntax data, and/or GOP-based syntax data, to video decoder 30, e.g., in a frame header, a block header, a slice header, or a GOP header. The GOP syntax data may describe a number of frames in the respective GOP, and the frame syntax data may indicate an encoding/prediction mode used to encode the corresponding frame. Video decoder 30 may therefore comprise a standard video decoder and need not necessarily be specially configured to effect or utilize the techniques of this disclosure.

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 20 and video decoder 30 may be included in one or more encoders or decoders, either of which may be integrated as part of a combined video encoder/decoder (CODEC). An apparatus including video encoder 20 and/or video decoder 30 may comprise an integrated circuit, a microprocessor, a computing device, and/or a wireless communication device, such as a mobile telephone.

Video decoder 30 may be configured to receive a scalable multi-view bitstream including a base layer and two enhancement layers. Video decoder 30 may further be configured to unpack the base layer into two corresponding sets of pictures, e.g., reduced resolution pictures of a left eye view and reduced resolution pictures of a right eye view. Video decoder 30 may decode the pictures and upsample (e.g., through interpolation) the reduced resolution pictures to produce decoded, full resolution pictures. In addition, in some examples, video decoder 30 may decode the enhancement layers, which include full resolution pictures corresponding to the base layer, with reference to the decoded pictures of the base layer. That is, video decoder 30 may also support inter-view and inter-layer prediction methods.

In some examples, video decoder 30 may be configured to determine whether destination device 14 is capable of decoding and displaying three-dimensional data. If not, video decoder 30 may unpack a received base layer, but discard one of the reduced resolution pictures. Video decoder 30 may also discard the full resolution enhancement layer that corresponds to the discarded reduced resolution pictures of the base layer. Video decoder 30 may decode the remaining reduced resolution picture, upsample or upconvert the reduced resolution picture, and cause video display 32 to display the pictures from this view to present two-dimensional video data. In another example, video decoder 30 may decode the remaining reduced resolution picture and the corresponding enhancement layer and cause video display 32 to display the pictures from this view to present two-dimensional video data. Thus, video decoder 30 may decode only a portion of the frames and provide the decoded pictures to display device 32, without attempting to decode all of the frames.

In this manner, whether or not destination device 14 is capable of displaying three-dimensional video data, destination device 14 may receive a scalable multi-view bitstream including a base layer and two enhancement layers. Thus, various destination devices with various decoding and rendering capabilities may be configured to receive the same bitstream from video encoder 20. That is, some destination devices may be capable of decoding and rendering three-dimensional video data while others may not be capable of decoding and/or rendering three-dimensional video data, yet each of the devices may be configured to receive and use data from the same scalable multi-view bitstream.

According to some examples, the scalable multi-view bitstream may include a plurality of operation points to facilitate decoding and displaying a subset of the received encoded data. For example, according to aspects of the disclosure, the scalable multi-view bitstream includes four operation points: (1) the base layer that includes reduced resolution pictures of two views (e.g., a left eye view and a right eye view), (2) the base layer and an enhancement layer that includes full resolution pictures of the left eye view, (3) the base layer and an enhancement layer that includes full resolution pictures of the right eye view, and (4) the base layer, the first enhancement layer and the second enhancement layer, such that the two enhancement layers together include full resolution pictures for both views.

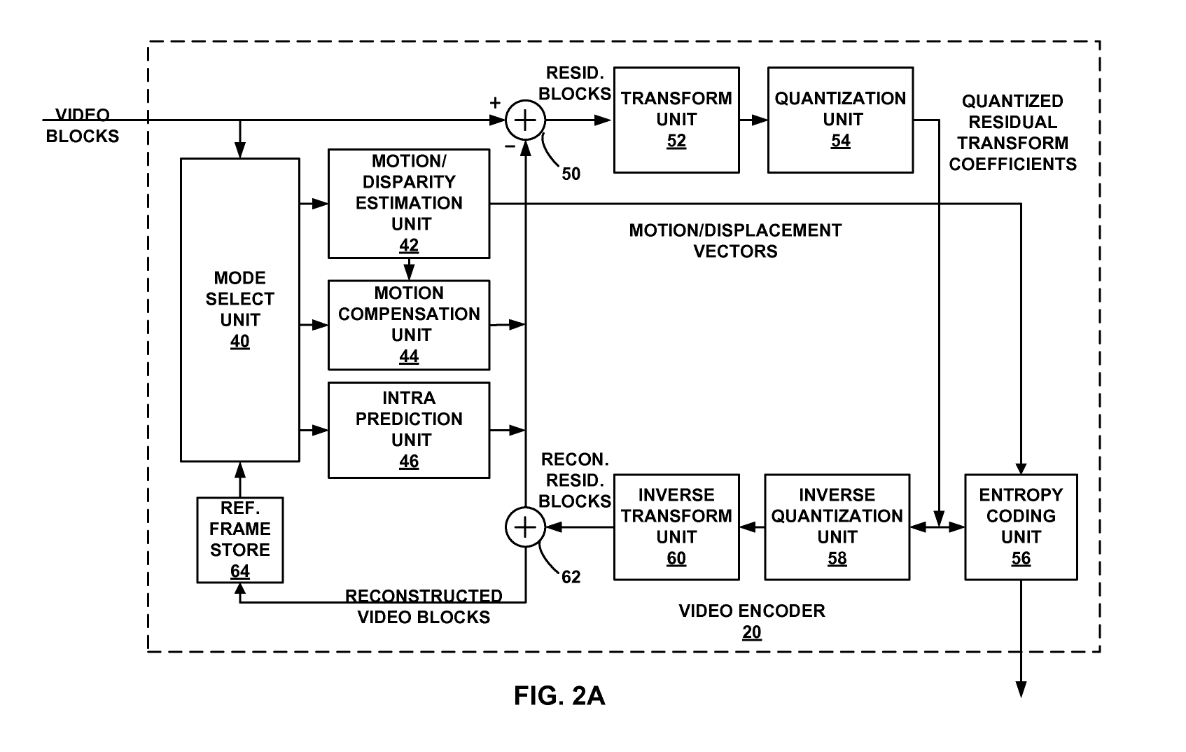

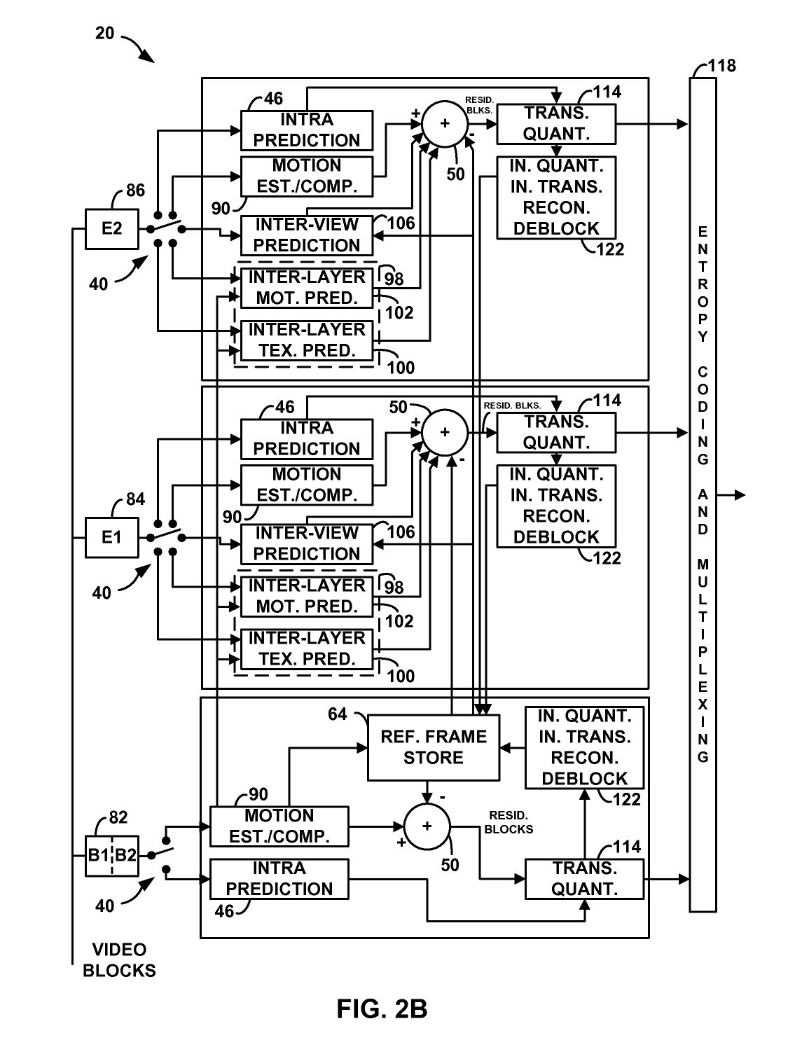

FIG. 2A is a block diagram illustrating an example of video encoder 20 that may implement techniques for producing a scalable multi-view bitstream having a base layer that includes reduced resolution pictures of two views of a scene (e.g., left eye view and right eye view), as well as a first enhancement layer that includes full resolution pictures of one of the views of the base layer and a second enhancement layer that includes full resolution pictures from the other respective view of the base layer. It should be understood that certain components of FIG. 2A may be shown and described with respect to a single component for conceptual purposes, but may include one or more functional units. In addition, while certain components of FIG. 2A may be shown and described with respect to a single component, such components may be physically comprised of one or more than one discrete and/or integrated units.

With respect to FIG. 2A, and elsewhere in this disclosure, video encoder 20 is described as encoding one or more frames of video data. As described above, a layer (e.g., the base layer and enhancement layers) may include a series of frames that make up multimedia content. Thus, a “base frame” may refer to a single frame of video data in the base layer. In addition, an “enhancement frame” may refer to a single frame of video data in an enhancement layer.

Generally, video encoder 20 may perform intra- and inter-coding of blocks within video frames, including macroblocks, or partitions or sub-partitions of macroblocks. Intra-coding relies on spatial prediction to reduce or remove spatial redundancy in video within a given video frame. Intra-mode (I-mode) may refer to any of several spatial based compression modes and inter-modes such as uni-directional prediction (P-mode) or bi-directional prediction (B-mode) may refer to any of several temporal-based compression modes. Inter-coding relies on temporal prediction to reduce or remove temporal redundancy in video within adjacent frames of a video sequence.

Video encoder 20 may also, in some examples, be configured to perform inter-view prediction and inter-layer prediction of the enhancement layers. For example, video encoder 20 may be configured to perform inter-view prediction in accordance with the multi-view video coding (MVC) extension of H.264/AVC. In addition, video encoder 20 may be configured to perform inter-layer prediction in accordance with the scalable video coding (SVC) extension of H.264/AVC. Accordingly, the enhancement layers may be inter-view predicted or inter-layer predicted from the base layer. In addition, one enhancement layer may be inter-view predicted from another enhancement layer.

As shown in FIG. 2A, video encoder 20 receives a current video block within a video picture to be encoded. In the example of FIG. 2A, video encoder 20 includes motion compensation unit 44, motion/disparity estimation unit 42, reference frame store 64, summer 50, transform unit 52, quantization unit 54, and entropy coding unit 56. For video block reconstruction, video encoder 20 also includes inverse quantization unit 58, inverse transform unit 60, and summer 62. A deblocking filter (not shown in FIG. 2A) may also be included to filter block boundaries to remove blockiness artifacts from reconstructed video. If desired, the deblocking filter would typically filter the output of summer 62.

During the encoding process, video encoder 20 receives a video picture or slice to be coded. The picture or slice may be divided into multiple video blocks. Motion estimation/disparity unit 42 and motion compensation unit 44 perform inter-predictive coding of the received video block relative to one or more blocks in one or more reference frames. That is, motion estimation/disparity unit 42 may perform inter-predictive coding of the received video block relative to one or more blocks in one or more reference frames of a different temporal instance, e.g., motion estimation using one or more reference frames of the same view. In addition, motion estimation/disparity unit 42 may perform inter-predictive coding of the received video block relative to one or more blocks in one or more reference frames of the same temporal instance, e.g., motion disparity using one or more reference frames of a different view. Intra prediction unit 46 may perform intra-predictive coding of the received video block relative to one or more neighboring blocks in the same frame or slice as the block to be coded to provide spatial compression. Mode select unit 40 may select one of the coding modes, intra or inter, e.g., based on error results, and provides the resulting intra- or inter-coded block to summer 50 to generate residual block data and to summer 62 to reconstruct the encoded block for use in a reference frame.

In particular, video encoder 20 may receive pictures from two views forming a stereo view pair. The two views may be referred to as view 0 and view 1, with view 0 corresponding to a left eye view picture and view 0 corresponding to a right eye view picture. It should be understood that the views may be labeled differently, and that instead, view 1 may correspond to the left eye view and view 0 may correspond to the right eye view.

In an example, video encoder 20 may encode a base layer by encoding pictures of view 0 and view 1 at a reduced resolution, such as half resolution. That is, video encoder 20 may downsample pictures of view 0 and view 1 by a factor of one-half prior to coding the pictures. Video encoder 20 may further pack the encoded pictures into a packed frame. Assume, for example, that video encoder 20 receives a view 0 picture and a view 1 picture, each having a height of h pixels and a width of w pixels, where w and h are non-negative, non-zero integers. Video encoder 20 may form a top-bottom arranged packed frame by downsampling the height of the view 0 picture and the view 1 picture to a height of h/2 pixels, and arranging the downsampled view 0 above the downsampled view 1. In another example, video encoder 20 may form a side-by-side arranged packed frame by downsampling the width of the view 0 picture and the view 1 picture to a width of w/2 pixels, and arranging the downsampled view 0 to the relative left of the downsampled view 1. The side-by-side and top-bottom frame packing arrangements are provided merely as examples, and it should be understood that video encoder 20 may pack the view 0 picture and view 1 picture of the base frame in other arrangements such as a checkerboard pattern, interleaving columns, or interleaving rows. For example, video encoder 20 may support frame packing in accordance with the H.264/AVC specification.

In addition to the base layer, video encoder 20 may encode two enhancement layers that correspond to the views included in the base layer. That is, video encoder 20 may encode full resolution pictures of view 0, as well as full resolution pictures of view 1. Video encoder 20 may perform inter-view perdition and inter-layer prediction to predict the two enhancement layers.

Video encoder 20 may further provide information indicating a variety of characteristics of the scalable multi-view bitstream. For example, video encoder 20 may provide data indicating a packing arrangement of the base layer, the sequence of the enhancement layers (e.g., whether the enhancement layer corresponding to view 0 comes before or after the enhancement layer corresponding to view 1), whether the enhancement layers are predicted from each other, and other information. As one example, video encoder 20 may provide this information in the form of a sequence parameter set (SPS) extension, which applies to a series of consecutively coded frames. The SPS extension may be defined according to the example data structure of Table 1, below:

TABLE 1
seq_parameter_set_mfc_extension SPS message

| seq_parameter_set_mfc_extension( ) { | C | Descriptor |
|---|---|---|
| upper_left_frame_0 | 0 | u(1) |
| left_view_enhance_first | 0 | u(1) |
| full_left_right_dependent_flag | 0 | u(1) |
| one_view_full_idc | 0 | u(2) |
| assymetric_flag | 0 | u(1) |
| inter_layer_pred_disable_flag | 0 | u(1) |
| inter_view_pred_disable_flag | 0 | u(1) |
| } | | |

The SPS message may inform a video decoder, such as video decoder 30, that the output decoded picture contains samples of a frame including multiple distinct spatially packed constituent frames using an indicated frame packing arrangement scheme. The SPS message may also inform video decoder 30 of characteristics of the enhancement frames.

In particular, video encoder 20 may set upper_left_frame_{—}0 to a value of 1 to indicate that the upper left luma sample of each constituent frame belongs to the left view, thereby indicating which portions of the base layer correspond to the left or right view. Video encoder 20 may set upper_left_frame_{—}0 to a value of 0 to indicate that the upper left luma sample of each constituent frame belongs to the right view.

This disclosure also refers to an encoded picture of a particular view as a “view component.” That is, a view component may comprise an encoded picture for a particular view (and/or a particular layer) at a particular time. Accordingly, an access unit may be defined as comprising all view components of a common temporal instance. The decoding order of access units, and view components of the access units, need not necessarily be the same as the output or display order.

Video encoder 20 may set left_view_enhance_first to specify the decoding order of the view components in each access unit. In some examples, video encoder 20 may set left_view_enhance_first to a value of 1 to indicate that the full resolution left view frame follows the base frame NAL units in the decoding order and that the full resolution right view frame follows the full resolution left view frame in the decoding order. Video encoder 20 may set left_view_enhance_first to a value of 0 to indicate that the full resolution right view frame follows the base frame NAL units in the decoding order and that the full resolution left view frame follows the full resolution right view frame in the decoding order.

Video encoder 20 may set full_left_right_dependent_flag to a value of 0 to indicate that the decoding of full resolution right view frame and full resolution left view frame is independent, which means that the decoding of the full resolution left view frame and the full resolution right view frame depend on the base view and do not depend on each other. Video encoder 20 may set full_left_right_dependent_flag to a value of 1 to indicate that one of the full resolution frames (e.g., either the full resolution right view frame or the full resolution left view frame) depends on the other full resolution frame.

Video encoder 20 may set one_viewfull_idc to a value of 0 to indicate that there is no operation point for a full resolution single view presentation. Video encoder 20 may set one_view_full_idc to a value of 1 to indicate that there are full resolution single view operation points allowed after extracting the third view component in the decoding order. Video encoder 20 may set one_view_full_idc to a value of 2 to indicate that besides the operation points supported when this value equal to 1, there are also full resolution single view operation points allowed after extracting the second view component in the decoding order.

Video encoder 20 may set asymmetric_flag to a value of 0 to indicate that no asymmetric operation points are allowed. Video encoder 20 may set asymmetric_flag to a value of 1 to indicate that asymmetric operation points are allowed, in a way that when any full resolution single view operation points are decoded, the full resolution view, together with the other view in the base view are allowed to form an asymmetric representation.

Video encoder 20 may set inter_layer_pred_disable_flag to a value of 1 to indicate that no inter-layer prediction is used when the bitstream is coded and when the sequence parameter set is active. Video encoder 20 may set inter_layer_pred_disable_flag to a value of 0 to indicate that inter-layer prediction might be used.

Video encoder 20 may set inter_view_pred_disable_flag to a value of 1 to indicate that no inter-view prediction is used when the bitstream is coded and when the sequence parameter set is active. Video encoder 20 may set inter_view_pred_disable_flag to a value of 1 to indicate that inter-view prediction might be used.

In addition to the SPS extension, video encoder 20 may provide a VUI message. In particular, for an asymmetric operation point, which corresponds to a full-resolution frame (e.g., one of the enhancement frames), video encoder may apply a VUI message to specify the cropping area of the base view. The cropped area combined with a full resolution view forms a representation for the asymmetric operation point. The cropped area may be described such that a full resolution picture can be distinguished from a reduced resolution picture in an asymmetric packed frame.

Video encoder 20 may also define a number of operation points for various combinations of base frames and enhancement frames. That is, video encoder may signal a variety of operation points in an operation point SEI. In an example, video encoder 20 may provide operation points via the SEI message provided in Table 2 below:

TABLE 2
operation_point_info(payloadSize) SEI message

| | | |
|---|---|---|
| operation_point_info( payloadSize ) { | | |
| max_temporal_id | 5 | u(3) |
| for( i = 0; i < (3+ full_left_right_dependent_flag ) ; | | |
| i++ ) { | | |
| profile_idc | 5 | u(8) |
| for ( j = 0; j <= max_temporal_id; j++ ) { | | |
| level_info_predict_flag[i][j] | 5 | u(1) |
| if ( !level_info_predict_flag[i][j] ) { | | |
| index_i | 5 | u(2) |
| index_j | 5 | u(2) |
| } | | |
| else | | |
| level_idc | 5 | u(8) |
| } | | |
| } | | |
| for ( j = 0; j <= max_temporal_id; j++ ) | | |
| average_frame_rate | 5 | u(16) |
| } | | |

According to some aspects of the disclosure, the SEI message can also be a part of the SPS extension described above. As with most video coding standards, H.264/AVC defines the syntax, semantics, and decoding process for error-free bitstreams, any of which conform to a certain profile or level. H.264/AVC does not specify the encoder, but the encoder is tasked with guaranteeing that the generated bitstreams are standard-compliant for a decoder. In the context of video coding standard, a “profile” corresponds to a subset of algorithms, features, or tools and constraints that apply to them. As defined by the H.264 standard, for example, a “profile” is a subset of the entire bitstream syntax that is specified by the H.264 standard. A “level” corresponds to the limitations of the decoder resource consumption, such as, for example, decoder memory and computation, which are related to the resolution of the pictures, bit rate, and macroblock (MB) processing rate. A profile may be signaled with a profile_idc (profile indicator) value, while a level may be signaled with a level_idc (level indicator) value.

The example SEI message of Table 2 describes operation points of a representation of video data. The max_temporal_id element generally corresponds to a maximum frame rate for the operation points of the representation. The SEI message also provides an indication of the profile of the bitstream and level for each of the operation points. The level_idc of the operation points may vary, however, an operation point may be the same as a previously signaled operation point, with temporal_id equal to index_j and layer id equal to index_i. The SEI message further describes an average frame rate for each of the temporal_id values using the average_frame_rate element. Although in this example an operation point SEI message is used to signal characteristics of operation points of a representation, it should be understood that in other examples, other data structures or techniques may be used to signal similar characteristics for operation points. For example, the signaling may form part of a sequence parameter set multiview frame compatible (MFC) extension.

Video encoder 20 may also generate a NAL unit header extension. According to aspects of the disclosure, video encoder 20 may generate a NAL unit header for the packed base frame, and a separate NAL unit header for the enhancement frames. In some examples, the base layer NAL unit header may be used to indicate the views of the enhancement layers are predicted from the base layer NAL unit. The enhancement layer NAL unit header may be used to indicate whether the NAL unit belongs to a second view, and to derive whether the second view is a left view. Moreover, the enhancement layer NAL unit header may be used for inter-view prediction of the other full resolution enhancement frame.

In an example, the NAL unit header for the base frame may be defined according to Table 3 below:

TABLE 3
nal_unit_header_base_view_extension NAL unit

| nal_unit_header_base_view_extension( ) { | C | Descriptor |
|---|---|---|
| anchor_pic_flag | All | u(1) |
| inter_view_frame_0_flag | All | u(1) |
| inter_view_frame_1_flag | All | u(1) |
| inter_layer_frame_0_flag | All | u(1) |
| inter_layer_frame_1_flag | All | u(1) |
| temporal_id | All | u(3) |
| } | | |

Video encoder 20 may set anchor_pic_flag to a value of 1 to specify that the current NAL unit belongs to an anchor access unit. In an example, when a non_idr_flag value to equal to 0, the video encoder 20 may set anchor_pic_flag to a value of 1. In another example, when a nal_ref_idc value is equal to 0, video encoder 20 may set anchor_pic_flag to a value of 0. According to some aspects of the disclosure, the value of anchor_pic_flag may be the same for all VCL NAL units of an access unit.

Video encoder 20 may set inter_view_frame_{—}0_flag to a value of 0 to specify that the frame 0 component (e.g., left view) of the current view component (e.g., current layer) is not used for inter-view prediction by any other view component (e.g., other layer) in the current access unit. Video encoder 20 may set inter_view_frame_{—}0_flag to a value of 1 to specify that the frame 0 component (e.g., left view) of the current view component may be used for inter-view prediction by other view components in the current access unit.

Video encoder 20 may set inter_view_frame_{—}1_flag to a value of 0 to specify that the frame 1 part (e.g., right view) of the current view component is not used for inter-view prediction by any other view component in the current access unit. Video encoder 20 may set inter_view_frame_{—}1_flag to a value of 1 to specify that the frame 1 part of the current view component may be used for inter-view prediction by other view components in the current access unit.

Video encoder 20 may set inter_layer_frame_{—}0_flag to a value of 0 to specify that the frame 0 part (e.g., left view) of the current view component is not used for inter-layer prediction by any other view component in the current access unit. Video encoder 20 may set inter_view_frame_{—}0_flag to a value of 1 to specify that the frame 0 part of the current view component may be used for inter-layer prediction by other view components in the current access unit.

Video encoder 20 may set inter_layer_frame_{—}1_flag to a value of 0 to specify that the frame 1 part (e.g., left view) of the current view component is not used for inter-layer prediction by any other view component in the current access unit. Video encoder 20 may set inter_view_frame_{—}1_flag to a value of 1 to specify that the frame 1 part of the current view component may be used for inter-layer prediction by other view components in the current access unit.

In another example, inter_view_frame_{—}0_flag and inter_view_frame_{—}1_flag may be combined into one flag. For example, video encoder 20 may set inter_view_flag, a flag that represents the combination of inter_view_frame_{—}0_flag and inter_view_frame_{—}1_flag described above, to a value of 1 if the frame 0 part or the frame 1 part may be used for inter-view prediction.

In another example, inter_layer_frame_{—}0_flag and inter layer_frame_{—}1_flag may be combined into one flag. For example, video encoder 20 may set inter_layer_flag, a flag that represents the combination of inter_layer_frame_{—}0_flag and inter layer_frame_{—}1_flag, to a value of 1 if the frame 0 part or the frame 1 part may be used for inter-layer prediction.

In another example, inter_view_frame_{—}0_flag and inter_layer_frame_{—}0_flag may be combined into one flag. For example, video encoder 20 may set inter_component_frame_{—}0_flag, a flag that represents the combination of inter_view_frame_{—}0_flag and inter_layer_frame_{—}0_flag to a value of 1 if the frame 0 part may be used for the prediction of other view components.

In another example, inter_view_frame_{—}1_flag and inter_layer_frame_{—}1_flag may be combined into one flag. For example, video encoder 20 may set inter_component_frame_{—}1_flag, a flag that represents the combination of inter_view_frame_{—}1_flag and inter_layer_frame_{—}1_flag, to a value of 1 if the frame 1 part may be used for the prediction of other view components.

In another example, inter_view_flag and inter_layer_flag may be combined into one flag. For example, video encoder 20 may set inter_component_flag, a flag that represents the combination of inter_view_flag and inter_layer_flag to a value of 1 if the frame 0 part or the frame 1 part may be used for inter-view or inter-layer prediction.

Video encoder 20 may set second_view_flag to indicate whether the belonging view component is the second view or the third view, where the “belonging view component” refers to the view component to which the second view flag corresponds. For example, video encoder 20 may set second_view_flag to a value of 1 to specify that the belonging view component is the second view. Video encoder 20 may set second_view_flag to a value of 0 to specify that the belonging view component is the third view.

Video encoder 20 may set the temporal_id to specify a temporal identifier for the NAL unit. The assignment of values to temporal_id may be constrained by the sub-bitstream extraction process. According to some examples, the value of temporal_id is the same for all prefix NAL units and coded slice in MFC extension NAL units of an access unit. When an access unit contains any NAL unit with nal_unit_type equal to 5 or idr_flag equal to 1, temporal_id may be equal to 0.

In an example, the NAL unit header for the full resolution enhancement frames may be defined according to Table 4 below:

TABLE 4
nal_unit_header_full_view_extension NAL unit

| nal_unit_header_full_view_extension( ) { | C | Descriptor |
|---|---|---|
| non_idr_flag | All | u(1) |
| anchor_pic_flag | All | u(1) |
| inter_view_flag | All | u(1) |
| second_view_flag | All | u(1) |
| temporal_id | All | u(3) |
| reserved_two_bits | All | u(2) |
| } | | |

The example NAL unit header of Table 4 may describe NAL units to which the header corresponds. The non-idr-flag may describe whether the NAL unit is an instantaneous decoding refresh (IDR) picture. An IDR picture is generally a picture of a group of pictures (GOP) that can be independently decoded (e.g., an intra-coded picture) and where all other pictures in the group of pictures can be decoded relative to the IDR picture or other pictures of the GOP. Thus, no picture of the GOP is predicted relative to a picture outside of the GOP. The anchor_pic_flag indicates whether the corresponding NAL unit corresponds to an anchor picture, that is, a coded picture in which all slices reference only slices within the same access unit (that is, no inter-prediction is used). The inter_view_flag indicates whether the picture corresponding to the NAL unit is used for inter-view prediction by any other view component in the current access unit. The second_view_flag indicates whether the view component corresponding to the NAL unit is the first enhancement layer or the second enhancement layer. The temporal_id value specifies a temporal identifier (which may correspond to a frame rate) for the NAL unit.

Mode select unit 40 may receive raw video data in the form of blocks from the view 0 picture and from the view 1 picture that corresponds in time to the view 0 picture. That is, the view 0 picture and the view 1 picture may have been captured at substantially the same time. According to some aspects of the disclosure, the view 0 picture and the view 1 picture may be downsampled and the video encoder may encode the downsampled pictures. For example, video encoder 20 may encode the view 0 picture and the view 1 picture in a packed frame. Video encoder 20 may also encode full resolution enhancement frames. That is, video encoder 20 may encode an enhancement frame that includes a full resolution view 0 picture and an enhancement frame that includes a full resolution view 1 picture. Video encoder 20 may store decoded versions of the view 0 picture and the view 1 picture in reference frame store 64 to facilitate inter-layer and inter-view prediction of the enhancement frames.

Motion estimation/disparity unit 42 and motion compensation unit 44 may be highly integrated, but are illustrated separately for conceptual purposes. Motion estimation is the process of generating motion vectors, which estimate motion for video blocks. A motion vector, for example, may indicate the displacement of a predictive block within a predictive reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. A motion vector may also indicate displacement of a partition of a macroblock. Motion compensation may involve fetching or generating the predictive block based on the motion vector (or displacement vector) determined by motion estimation/disparity unit 42. Again, motion estimation/disparity unit 42 and motion compensation unit 44 may be functionally integrated, in some examples.

Motion estimation/disparity unit 42 may calculate a motion vector (or a disparity vector) for a video block of an inter-coded picture by comparing the video block to video blocks of a reference frame in reference frame store 64. Motion compensation unit 44 may also interpolate sub-integer pixels of the reference frame, e.g., an I-frame or a P-frame. The ITU-T H.264 standard refers to “lists” of reference frames, e.g., list 0 and list 1. List 0 includes reference frames having a display order earlier than the current picture, while list 1 includes reference frames having a display order later than the current picture. Motion estimation/disparity unit 42 compares blocks of one or more reference frames from reference frame store 64 to a block to be encoded of a current picture, e.g., a P-picture or a B-picture. When the reference frames in reference frame store 64 include values for sub-integer pixels, a motion vector calculated by motion estimation/disparity unit 42 may refer to a sub-integer pixel location of a reference frame. Motion estimation/disparity unit 42 sends the calculated motion vector to entropy coding unit 56 and motion compensation unit 44. The reference frame block identified by a motion vector may be referred to as a predictive block. Motion compensation unit 44 calculates residual error values for the predictive block of the reference frame.

Motion estimation/disparity unit 42 may also be configured to perform inter-view prediction, in which case motion estimation/disparity unit 42 may calculate displacement vectors between blocks of one view picture (e.g., view 0) and corresponding blocks of a reference frame view picture (e.g., view 1). Alternatively or additionally, motion estimation/disparity unit 42 may be configured to perform inter-layer prediction. That is, motion estimation/disparity unit 42 may be configured to perform motion-based inter-layer prediction, in which case motion estimation/disparity unit 42 may calculate predictors based on scaled motion vectors associated with the base frame.

As described above, intra-prediction unit 46 may perform intra-predictive coding of the received video block relative to one or more neighboring blocks in the same frame or slice as the block to be coded to provide spatial compression. According to some examples, intra-prediction unit 46 may be configured to perform inter-layer prediction of the enhancement frames. That is, intra-prediction unit 46 may be configured to perform texture based inter-layer prediction, in which case intra-prediction unit 46 may upsample the base frame and calculate predictors based on co-located textures in the base frame and enhancement frame. In some examples, inter-layer texture based prediction is only available for blocks of an enhancement frame that has co-located blocks in a corresponding base frame that are coded as constrained intra modes. For example, a constrained intra mode block is intra-coded without referring to any samples from the neighboring blocks that are inter-coded.

According to aspects of the disclosure, each of the layers, e.g., the base layer, the first enhancement layer, and the second enhancement layer, may be encoded independently. Assume for example, the video encoder 20 encodes three layers: (1) the base layer with reduced resolution pictures of view 0 (e.g., left eye view) and view 1 (e.g., right eye view), (2) a first enhancement layer with a full resolution picture of view 0, and (3) a second enhancement layer with a full resolution picture of view 1. In this example the video encoder 20 may implement different coding modes (e.g., via mode select unit 40) for each layer.

In this example, motion estimation/disparity unit 42 and motion compensation unit 44 may be configured to inter-code the two reduced resolution pictures of the base layer. That is, motion estimation/disparity unit 42 may calculate a motion vector for a video block of the pictures of a base frame by comparing the video block to video blocks of a reference frame in reference frame store 64, while motion compensation unit 44 may calculate residual error values for the predictive block of the reference frame. Alternatively or additionally, intra-prediction unit 46 may intra-code the two reduced resolution pictures of the base layer.

Video encoder 20 may also implement motion estimation/disparity unit 42, motion compensation unit 44, and intra-prediction unit 46 to intra-predict, inter-predict, inter-layer predict, or inter-view predict each of the enhancement layers, i.e., the first enhancement layer (e.g., corresponding to view 0) and the second enhancement layer (e.g., corresponding to view 1). For example, in addition to intra-prediction and inter-prediction modes, video encoder 20 may utilize the reduced resolution pictures of view 0 of the base layer to inter-layer predict the full resolution pictures of the first enhancement layer. Alternatively, video encoder 20 may utilize the reduced resolution pictures of view 1 of the base layer to inter-view predict the full resolution pictures of the first enhancement layer. According to some aspects of the disclosure, the reduced resolution pictures of the base layer may be upsampled or otherwise reconstructed prior to predicting the enhancement layers with inter-layer or inter-view prediction methods.

When predicting the first enhancement layer using inter-layer prediction, video encoder 20 may use texture prediction or motion prediction methods. When using texture based inter-layer prediction to predict the first enhancement layer, video encoder 20 may upsample the pictures of view 0 of the base layer to full resolution, and video encoder 20 may use the co-located texture of the pictures of view 0 of the base layer as a predictor for the pictures of the first enhancement layer. Video encoder 20 may upsample the pictures of view 0 of the base layer using a variety of filters, including adaptive filters. Video encoder 20 may encode the residual (e.g., the residual between the predictor and the original texture in the pictures of view 0 of the base layer) using the same method as described above with respect to a motion compensated residual. At the decoder (e.g., such as video decoder 30 shown in FIG. 1), the decoder 30 may reconstruct the pixel values using the predictor and residual values.

When using motion based inter-layer prediction to predict the first enhancement layer from the corresponding reduced resolution pictures of the base layer, video encoder 20 may scale the motion vectors associated with the pictures of view 0 of the base layer. For example, in an arrangement in which the pictures of view 0 and the pictures of view 1 are packed side-by-side in the base layer, video encoder 20 may scale the motion vectors associated with the predicted pictures of view 0 of the base layer in the horizontal direction to compensate for the difference between the reduced resolution base layer and the full resolution enhancement layer. In some examples, video encoder 20 may further refine the motion vectors associated with the pictures of view 0 of the base layer by signaling a motion vector difference (MVD) value, which accounts for the difference between the motion vectors associated with the reduced resolution base layer and the motion vectors associated with the full resolution enhancement layer.

In another example, video encoder 20 may perform inter-layer motion prediction using a motion skip technique, which is defined in a Joint Multiview Video Model (“JMVM”) extension to H.264/AVC. The JMVM is extension is discussed, for example, in JVT-U207, 21^{st} JVT meeting, Hangzhou, China, Oct. 20-27, 2006, available at http://ftp3.itu.int/av-arch/jvt-site/2006_{—}10_Hangzhou/JVT-U207.zip. The motion skip technique may enable video encoder 20 to reuse motion vectors from a picture in the same time instance but of another view by a given disparity. In some examples, the disparity value may be signaled globally and extended locally to each block or slice that uses the motion skip technique. According to some aspects, video encoder 20 may set the disparity value to zero, because the portion of the base layer being used to predict the enhancement layer are co-located.

When predicting frames of the first enhancement layer using inter-view prediction, video encoder 20 may, similar to inter-coding, utilize motion estimation/disparity unit 42 to calculate displacement vectors between blocks of the enhancement layer frames and corresponding blocks of reference frames (e.g., the pictures of view 1 of the base frame). In some examples, video encoder 20 may upsample the pictures of view 1 of the base frame prior to predicting the first enhancement layer. That is, video encoder 20 may upsample the pictures of the view 1 component of the base layer and store the upsampled pictures in the reference frame store 64 so that they can be utilized for prediction purposes. According to some examples, video encoder 20 may only use inter-view prediction to encode a block or block partition when the reference block or block partition of the base frame has been inter-coded.

According to some aspects of the disclosure, video encoder 20 may encode the second enhancement layer (e.g., corresponding to view 1) similarly or the same as the first enhancement layer. That is, video encoder 20 may utilize the reduced resolution pictures of view 1 of the base layer to predict the second enhancement layer (e.g., full resolution pictures of view 1) using inter-layer prediction. Video encoder 20 may also utilize the reduced resolution pictures of view 0 of the base layer to predict the second enhancement layer using inter-view prediction. According to this example, the enhancement layers, i.e., the first enhancement layer and the second enhancement layer, do not depend on each other. Rather, the second enhancement layer uses only the base layer for prediction purposes.

Additionally or alternatively, video encoder 20 may encode the second enhancement layer (e.g., full resolution pictures of view 1) using the first enhancement layer (e.g., full resolution pictures of view 0) for prediction purposes. That is, the first enhancement layer may be used to predict the second enhancement layer using inter-view prediction. For example, the full resolution pictures of view 0 from the first enhancement layer may be stored in the reference frame store 64 so that they can be utilized for prediction purposes when encoding the second enhancement layer.

Transform unit 52 applies a transform, such as a discrete cosine transform (DCT), integer transform, or a conceptually similar transform, to the residual block, producing a video block comprising residual transform coefficient values. Transform unit 52 may perform other transforms, such as those defined by the H.264 standard, which are conceptually similar to DCT. Wavelet transforms, integer transforms, sub-band transforms or other types of transforms could also be used. In any case, transform unit 52 applies the transform to the residual block, producing a block of residual transform coefficients. Transform unit 52 may convert the residual information from a pixel value domain to a transform domain, such as a frequency domain. Quantization unit 54 quantizes the residual transform coefficients to further reduce bit rate. The quantization process may reduce the bit depth associated with some or all of the coefficients. The degree of quantization may be modified by adjusting a quantization parameter.

Following quantization, entropy coding unit 56 entropy codes the quantized transform coefficients. For example, entropy coding unit 56 may perform content adaptive variable length coding (CAVLC), context adaptive binary arithmetic coding (CABAC), or another entropy coding technique. Following the entropy coding by entropy coding unit 56, the encoded video may be transmitted to another device or archived for later transmission or retrieval. In the case of context adaptive binary arithmetic coding (CABAC), context may be based on neighboring macroblocks.

In some cases, entropy coding unit 56 or another unit of video encoder 20 may be configured to perform other coding functions, in addition to entropy coding. For example, entropy coding unit 56 may be configured to determine the CBP values for the macroblocks and partitions. Also, in some cases, entropy coding unit 56 may perform run length coding of the coefficients in a macroblock or partition thereof. In particular, entropy coding unit 56 may apply a zig-zag scan or other scan pattern to scan the transform coefficients in a macroblock or partition and encode runs of zeros for further compression. Entropy coding unit 56 also may construct header information with appropriate syntax elements for transmission in the encoded video bitstream.

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference frame store 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference frame store 64. The reconstructed video block may be used by motion estimation/disparity unit 42 and motion compensation unit 44 as a reference block to inter-code a block in a subsequent video frame.

To enable inter-prediction and inter-view prediction, as described above, video encoder 20 may maintain one or more reference lists. For example, the ITU-T H.264 standard refers to “lists” of reference frames, e.g., list 0 and list 1. Aspects of the disclosure relate to constructing a reference picture list that provides flexible ordering of reference pictures for inter-prediction and inter-view prediction. According to some aspects of the disclosure, video encoder 20 may construct a reference picture list according to a modified version of that described in the H.264/AVC specification. For example, video encoder 20 may initialize a reference picture list as set forth in the H.264/AVC specification, which maintains reference pictures for inter-prediction purposes. According to aspects of the disclosure, inter-view reference pictures are then appended to the list.

When encoding a non-base layer component (e.g., the first or second enhancement layer), video encoder 20 may make only one inter-view reference available. For example, when encoding the first enhancement layer, the inter-view reference picture may be an upsampled corresponding picture of the base layer within the same access unit. In this example, full_left_right_dependent_flag may be equal to 1 and depViewID may be set to 0. When encoding the second enhancement layer, the inter-view reference picture may be an upsampled corresponding picture of the base layer within the same access unit. In this example, full_left_right_dependent_flag may be equal to 0 and depViewID may be set to 0. Alternatively, the inter-view reference picture may be the full resolution first enhancement layer in the same access unit. Accordingly, full_left_right_dependent_flag may be equal to 0 and depViewID may be set to 1. A client device may use this information to determine what data is necessary to retrieve in order to successfully decode the enhancement layers.

The reference picture list may be modified to flexibly arrange the order of reference pictures. For example, video encoder 20 may construct a reference picture list according to Table 5 below:

TABLE 5
ref_pic_list_mfc_modification( )

| ref_pic_list_mfc_modification( ) { | C | Descriptor |
|---|---|---|
| if( slice_type % 5 != 2 && slice_type % 5 != 4 ) { | | |
| ref_pic_list_modification_flag_l0 | 2 | u(1) |
| if( ref_pic_list_modification_flag_l0 ) | | |
| do { | | |
| modification_of_pic_nums_idc | 2 | ue(v) |
| if( modification_of_pic_nums_idc == 0 \|\| | | |
| modification_of_pic_nums_idc == 1 ) | | |
| abs_diff_pic_num_minus1 | 2 | ue(v) |
| else if( modification_of_pic_nums_idc == | | |
| 2 ) | | |
| long_term_pic_num | 2 | ue(v) |
| else if ( modification_of_pic_nums_idc == | | |
| 4 \|\| | | |
| modification_of_pic_nums_idc == | | |
| 5 ) | | |
| abs_diff_view_idx_minus1 | 2 | ue(v) |
| } while( modification_of_pic_nums_idc != 3 ) | | |
| } | | |
| if( slice_type % 5 == 1 ) { | | |
| ref_pic_list_modification_flag_l1 | 2 | u(1) |
| if( ref_pic_list_modification_flag_l1 ) | | |
| do { | | |
| modification_of_pic_nums_idc | 2 | ue(v) |
| if( modification_of_pic_nums_idc == 0 \|\| | | |
| modification_of_pic_nums_idc == 1 ) | | |
| abs_diff_pic_num_minus1 | 2 | ue(v) |
| else if( modification_of_pic_nums_idc == | | |
| 2 ) | | |
| long_term_pic_num | 2 | ue(v) |
| else if ( modification_of_pic_nums_idc == | | |
| 6 ) | | |
| continue; // no extra value needs to be | 1 | u(1) |
| signalled in this case. | | |
| } while( modification_of_pic_nums_idc != 3 ) | | |
| } | | |
| } | | |

The example reference picture list modification of Table 5 may describe the reference picture lists. For example, modification_of_pic_nums_idc together with abs_diff_pic_num_minus1, long_term_pic_num, or abs_diff_view_idx_minus 1 may specify which of the reference pictures or inter-view only reference components are re-mapped. For inter-view prediction, the inter-view reference picture and the current picture may, by default, belong to two opposite views of the stereo content. In some examples, the inter-view reference picture may correspond to a decoded picture that is part of a base layer. Accordingly, upsampling may be needed before the decoded picture is used for inter-view prediction. The low resolution picture of the base layer may be upsampled using a variety of filters, including adaptive filters, as well as the AVC 6-tap interpolation filter: [1, −5, 20, 20, −5, 1]/32.

In another example, for inter-view prediction, the inter-view reference picture may correspond to the same view as the current picture (e.g., a different decoded resolution in the same access unit) and a different view. In that case, as shown in Table 6 (below), a collocated_flag is introduced to indicate whether the current picture and the inter-view prediction picture correspond to the same view. If collocated_flag is equal to 1, the inter-view reference picture and the current picture may both be representations of the same view (e.g., the left view or right view, similar to inter-layer texture prediction). If collocated_flag is equal to 0, the inter-view reference picture and the current picture may be representations of different views (e.g., one left view picture and one right view picture).

TABLE 6
ref_pic_list_mfc_modification( )

| ref_pic_list_mfc_modification( ) { | C | Descriptor |
|---|---|---|
| if( slice_type % 5 != 2 && slice_type % 5 != 4 ) { | | |
| ref_pic_list_modification_flag_l0 | 2 | u(1) |
| if( ref_pic_list_modification_flag_l0 ) | | |
| do { | | |
| modification_of_pic_nums_idc | 2 | ue(v) |
| if( modification_of_pic_nums_idc == 0 \|\| | | |
| modification_of_pic_nums_idc == 1 ) | | |
| abs_diff_pic_num_minus1 | 2 | ue(v) |
| else if( modification_of_pic_nums_idc == | | |
| 2 ) | | |
| long_term_pic_num | 2 | ue(v) |
| else if ( modification_of_pic_nums_idc == | | |
| 4 \|\| | | |
| modification_of_pic_nums_idc == | | |
| 5 ) | | |
| abs_diff_view_idx_minus1 | 2 | ue(v) |
| } while( modification_of_pic_nums_idc != 3 ) | | |
| } | | |
| if( slice_type % 5 == 1 ) { | | |
| ref_pic_list_modification_flag_l1 | 2 | u(1) |
| if( ref_pic_list_modification_flag_l1 ) | | |
| do { | | |
| modification_of_pic_nums_idc | 2 | ue(v) |
| if( modification_of_pic_nums_idc == 0 \|\| | | |
| modification_of_pic_nums_idc == 1 ) | | |
| abs_diff_pic_num_minus1 | 2 | ue(v) |
| else if( modification_of_pic_nums_idc == | | |
| 2 ) | | |
| long_term_pic_num | 2 | ue(v) |
| else if ( modification_of_pic_nums_idc == | | |
| 6 ) | | |
| colocated_flag | 1 | u(1) |
| } while( modification_of_pic_nums_idc != 3 ) | | |
| } | | |
| } | | |

According to some aspects of the disclosure, the values of modification_of_pic_nums_idc are specified in Table 7 (below). In some examples, the value of the first modification_of_pic_nums_idc that follows immediately after ref_pic_list_modification_flag_{—}10 or ref_pic_list_modification_flag_{—}11 may not be equal to 3.

TABLE 7
modification_of_pic_nums_idc

| modification_of_pic_nums_idc | Modification specified |
|---|---|
| 0 | abs_diff_pic_num_minus1 is |
| | present and corresponds to |
| | a difference to subtract from a |
| | picture number prediction value |
| 1 | abs_diff_pic_num_minus1 is |
| | present and corresponds to a |
| | difference to add to a picture |
| | number prediction value |
| 2 | long_term_pic_num is |
| | present and specifies the long-term |
| | picture number for a reference picture |
| 3 | End loop for modification of the |
| | initial reference picture list |
| 6 | Such a value indicates that the |
| | inter-view reference is used |

According to aspects of the disclosure, abs_diff_view_idx_minus1 plus 1 may specify the absolute difference between the inter-view reference index to put to the current index in the reference picture list and the prediction value of the inter-view reference index. During the decoding process for the syntax presented in Tables 6 and 7 above, when modification_of_pic_nums_idc (Table 7) is equal to 6, the inter-view reference picture will be put into the current index position of the current reference picture list.

The following procedure is conducted to place the picture with short-term picture number picNumLX into the index position refIdxLX, shift the position of any other remaining pictures to later in the list, and increment the value of refIdxLX:

for( cIdx = num_ref_idx_lX_active_minus1 + 1; cIdx > refIdxLX;
cIdx−− )
RefPicListX[ cIdx ] = RefPicListX[ cIdx − 1]
RefPicListX[ refIdxLX++ ] = short-term reference picture with PicNum
equal to picNumLX

| | | |
|---|---|---|
| nIdx | = | refIdxLX |

```
for( cIdx = refIdxLX; cIdx <= num_ref_idx_lX_active_minus1 + 1;
cIdx++ )
  if( PicNumF( RefPicListX[ cIdx ] ) != picNumLX ||
viewID(RefPicListX[ cIdx  ] )  !=
depViewID  )
    RefPicListX[ nIdx++ ] = RefPicListX[ cIdx ]
```

where viewID ( ) returns to the view_id of each view component. When a reference picture is an upsampled version of a picture from the base layer, the viewID( ) may return to the same view_id of the base layer, which is 0. When a reference picture does not belong to the base layer (e.g., the reference picture is the first enhancement layer), the viewID ( ) may return to the view_id of the appropriate view, which may be 1 (first enhancement layer) or 2 (second enhancement layer).

Video encoder 20 may also provide certain syntax with the encoded video data, e.g., information used by a decoder (decoder 30, FIG. 1) to properly decode encoded video data. According to some aspects of the disclosure, to enable inter-layer prediction, video encoder 20 may provide syntax elements in a slice header to indicate that (1) no blocks are inter-layer texture predicted in the slice, (2) all blocks are inter-layer texture predicted in the slice, or (3) some blocks may be inter-layer texture predicted and some blocks may not be inter-layer texture predicted in the slice. In addition, video encoder 20 may provide syntax elements in a slice header to indicate that (1) no blocks are inter-layer motion predicted in the slice, (2) all blocks are inter-layer motion predicted in the slice, or (3) some blocks may be inter-layer motion predicted and some blocks may not be inter-layer motion predicted in the slice.

In addition, to enable inter-layer prediction, video encoder 20 may provide some syntax data at block level. For example, aspects of the disclosure include a syntax element named mb_base_texture_flag. This flag may be used to indicate whether inter-layer texture prediction is invoked for an entire block (e.g., an entire macroblock). Video encoder 20 may set mb_base_texture_flag equal to 1 to signal that the reconstructed pixels in the corresponding base layer are used as a reference to reconstruct a current block using inter-layer texture prediction. In addition, video encoder may set mb_base_texture_flag equal to 1 to signal that the coding of other syntax elements in the current block is skipped, except those for residual coding (i.e., CBP, 8×8 transform flag, and coefficients). Video encoder 20 may set mb_base_texture_flag equal to 0 to signal that regular block coding is applied. If the block is a regular intra-block, the coding process is identical to the regular intra-block coding set forth in the H.264/AVC specification.

To enable inter-layer prediction, video encoder 20 may provide other syntax data at block level. For example, aspects of the disclosure include a syntax element named mbPart_texture_prediction_flag [mbPartIdx] is coded to indicate whether video encoder 20 uses inter-layer prediction to encode the partition mbPartIdx. This flag may apply to blocks with partition types of inter 16×16, 8×16, 16×8, and 8×8, but generally not below 8×8. Video encoder 20 may set mbPart_texture_prediction_flag equal to 1 to indicate that inter-layer texture prediction is applied to the corresponding partition. Video encoder 20 may set mbPart_texture_prediction_flag equal to 0 to indicate that a flag called motion_prediction_flag_{—}10/1 [mbPartIdx] is coded. Video encoder 20 may set motion_prediction_flag_{—}10/1 equal to 1 to indicate that the motion vector of the partition mbPartIdx may be predicted using the motion vector of the corresponding partition in the base layer. Video encoder 20 may set motion_prediction_flag_{—}10/1 equal to 0 to indicate that motion vectors are reconstructed in the same way as that in the H.264/AVC specification.

Table 8, shown below, includes block level syntax elements:

TABLE 8
macroblock_layer_in_mfc_extension( )

| macroblock_layer_in_mfc_extension( ) { | C | Descriptor |
|---|---|---|
| mb_base_texture_flag | 2 | u(1)\| |
| | | ae(v) |
| if( ! mb_base_texture_flag) { | | |
| mb_type | 2 | ue(v)\| |
| | | ae(v) |
| if(mb_type = = I_PCM ) { | | |
| while( !byte_aligned( ) ) | | |
| pcm_alignment_zero_bit | 3 | f(1) |
| for( i = 0; i < 256; i++ ) | | |
| pcm_sample_luma[ i ] | 3 | u(v) |
| for( i = 0; i < 2 * MbWidthC * MbHeightC; i++ ) | | |
| pcm_sample_chroma[ i ] | 3 | u(v) |
| } else { | | |
| noSubMbPartSizeLessThan8×8Flag = 1 | | |
| if( mb_type != I_N×N && | | |
| MbPartPredMode( mb_type, 0 ) != | | |
| Intra_16×16 && | | |
| NumMbPart( mb_type ) = = 4 ) { | | |
| sub_mb_pred_in_mfc_extension | | |
| ( mb_type ) | 2 | |
| for( mbPartIdx = 0; mbPartIdx < 4; | | |
| mbPartIdx++ ) | | |
| if( sub_mb_type[ mbPartIdx ] != | | |
| B_Direct_8×8 ) { | | |
| if( NumSubMbPart( sub_mb_type | | |
| [ mbPartIdx ] ) > 1 ) | | |
| noSubMbPartSizeLessThan8×8Flag = 0 | | |
| } else if( !direct_8×8_inference_flag ) | | |
| noSubMbPartSizeLessThan8×8Flag = 0 | | |
| } else { | | |
| if( transform_8×8_mode_flag && | | |
| mb_type = = I_N×N ) | | |
| transform_size_8×8_flag | 2 | u(1)\| |
| | | ae(v) |
| mb_pred_in_mfc_extension( mb_type ) | 2 | |
| } | | |
| } | | |
| } | | |
| if( scan_idx_end >= scan_idx_start ) { | | |
| if( base_mode_flag \|\| | | |
| MbPartPredMode( mb_type, 0 ) != | | |
| Intra_16×16 ) { | | |
| coded_block_pattern | 2 | me(v)\| |
| | | ae(v) |
| if( CodedBlockPatternLuma > 0 && | | |
| transform_8×8_mode_flag && | | |
| ( base_mode_flag \|\| | | |
| ( mb_type != I_N×N && | | |
| noSubMbPartSizeLessThan8×8Flag && | | |
| ( mb_type != B_Direct_16×16 \|\| | | |
| direct_8×8_inference_flag ) ) ) ) | | |
| transform_size_8×8_flag | 2 | u(1)\| |
| | | ae(v) |
| } | | |
| if( CodedBlockPatternLuma > 0 \|\| | | |
| CodedBlockPatternChroma > 0 \|\| | | |
| ( | | |
| MbPartPredMode( mb_type, 0 ) = = | | |
| Intra_16×16 ) ) { | | |
| mb_qp_delta | 2 | se(v)\| |
| | | ae(v) |
| residual(scan_idx_start, scan_idx_end ) | 3\|4 | |
| } | | |
| } | | |
| } | | |

In the example shown in Table 8, video encoder 20 may set mb_base_texture_flag equal to 1 to indicate that inter-layer texture prediction is applied for an entire macroblock. In addition, video encoder 20 may set mb_base_texture_flag equal to 0 to indicate that the syntax element mb_type and other related syntax elements are present in the macroblock in the “multi-view frame compatible” MFC structure.

Table 9, shown below, also includes block level syntax elements:

TABLE 9
mb_pred_in_mfc_extension( mb_type )

| mb_pred_in_mfc_extension( mb_type ) { | C | Descriptor |
|---|---|---|
| if( MbPartPredMode( mb_type, 0 ) = = Intra_4×4 \|\| | | |
| MbPartPredMode( mb_type, 0 ) = = Intra_8×8 \|\| | | |
| MbPartPredMode( mb_type, 0 ) = = | | |
| Intra_16×16 ) { | | |
| if( MbPartPredMode( mb_type, 0 ) = = Intra_4×4 ) | | |
| for( luma4×4BlkIdx = 0; luma4×4BlkIdx < 16; | | |
| luma4×4BlkIdx++ ) { | | |
| prev_intra4×4_pred_mode_flag[ | 2 | u(1)\| |
| luma4×4BlkIdx ] | | ae(v) |
| if( !prev_intra4×4_pred_mode_flag[ | | |
| luma4×4BlkIdx ] ) | | |
| rem_intra4×4_pred_model[ | 2 | u(3)\| |
| luma4×4BlkIdx ] | | ae(v) |
| } | | |
| if( MbPartPredMode( mb_type, 0 ) = = Intra_8×8 ) | | |
| for( luma8×8BlkIdx = 0; luma8×8BlkIdx < 4; | | |
| luma8×8BlkIdx++ ) { | | |
| prev_intra8×8_pred_mode_flag[ | 2 | u(1)\| |
| luma8×8BlkIdx ] | | ae(v) |
| if( !prev_intra8×8_pred_mode_flag[ | | |
| luma8×8BlkIdx ] ) | | |
| rem_intra8×8_pred_mode[ | 2 | u(3)\| |
| luma8×8BlkIdx ] | | ae(v) |
| } | | |
| if( ChromaArrayType != 0 ) | | |
| intra_chroma_pred_mode | 2 | ue(v)\| |
| | | ae(v) |
| } else if( MbPartPredMode( mb_type, 0 ) != | | |
| Direct ) { | | |
| for( mbPartIdx = 0; mbPartIdx < | | |
| NumMbPart( mb_type ); mbPartIdx++) | | |
| mbPart_texture_prediction_flag[ mbPartIdx ] | 2 | u(1)\| |
| | | ae(v) |
| for( mbPartIdx = 0; mbPartIdx < | | |
| NumMbPart( mb_type ); mbPartIdx++) | | |
| if(! mbPart_texture_prediction_flag[ | | |
| mbPartIdx ] | | |
| &&MbPartPredMode( mb_type, mbPartIdx ) != | | |
| Pred_L1 ) | | |
| motion_prediction_flag_l0[ mbPartIdx ] | 2 | u(1)\| |
| | | ae(v) |
| for( mbPartIdx = 0; mbPartIdx < | | |
| NumMbPart( mb_type ); mbPartIdx++) | | |
| if(! mbPart_texture_prediction_flag[ | | |
| mbPartIdx ] | | |
| &&MbPartPredMode( mb_type, mbPartIdx ) != | | |
| Pred_L0 ) | | |
| motion_prediction_flag_l1[ mbPartIdx ] | 2 | u(1)\| |
| | | ae(v) |
| for( mbPartIdx = 0; mbPartIdx < | | |
| NumMbPart( mb_type ); mbPartIdx++) | | |
| if( (! mbPart_texture_prediction_flag[ | | |
| mbPartIdx ] && | | |
| !motion_prediction_flag_l0[ | | |
| mbPartIdx ]&& | | |
| (num_ref_idx_l0_active_minus1 > 0 \|\| | | |
| mb_field_decoding_flag ) && | | |
| MbPartPredMode( mb_type, mbPartIdx) != | | |
| Pred_L1) | | |
| ref_idx_l0[ mbPartIdx ] | 2 | te(v)\| |
| | | ae(v) |
| for( mbPartIdx = 0; mbPartIdx < | | |
| NumMbPart( mb_type ); mbPartIdx++) | | |
| if((! mbPart_texture_prediction_flag[ | | |
| mbPartIdx ] && | | |
| !motion_prediction_flag_l1[ | | |
| mbPartIdx ]&& | | |
| ( num_ref_idx_l1_active_minus1 > 0 \|\| | | |
| mb_field_decoding_flag )&& | | |
| MbPartPredMode( mb_type, mbPartIdx ) != | | |
| Pred_L0 && | | |
| !motion_prediction_flag_l1[ mbPartIdx ]) | | |
| ref_idx_l1[ mbPartIdx ] | 2 | te(v)\| |
| | | ae(v) |
| for( mbPartIdx = 0; mbPartIdx < | | |
| NumMbPart( mb_type ); mbPartIdx++) | | |
| if(mbPart_texture_prediction_flag[ | | |
| mbPartIdx ] && | | |
| MbPartPredMode ( mb_type, mbPartIdx ) != | | |
| Pred_L1 ) | | |
| for( compIdx = 0; compIdx < 2; compIdx++ ) | | |
| mvd_l0[ mbPartIdx ][ 0 ][ compIdx ] | 2 | se(v)\| |
| | | ae(v) |
| for( mbPartIdx = 0; mbPartIdx < | | |
| NumMbPart( mb_type ); mbPartIdx++) | | |
| if(mbPart_texture_prediction_flag[ | | |
| mbPartIdx ]&& | | |
| MbPartPredMode( mb_type, mbPartIdx ) != | | |
| Pred_L0 ) | | |
| for( compIdx = 0; compIdx < 2; compIdx++ ) | | |
| mvd_l1[ mbPartIdx ][ 0 ][ compIdx ] | 2 | se(v)\| |
| | | ae(v) |
| } | | |
| } | | |

In the example shown in Table 8, video encoder 20 may set mbPart_texture_prediction_flag[mbPartIdx] equal to 1 to indicate that inter-layer texture prediction is invoked for the corresponding partition mbPartIdx. Video encoder 20 may set mbPart_texture_prediction_flag equal to 0 to indicate that no inter-layer texture prediction is invoked for the partition mbPartIdx. In addition, video encoder 20 may set motion_prediction_flag_{—}11/0[mbPartIdx] equal to 1 to indicate that an alternative motion vector prediction process using the motion vector of the base layer as a reference is used for deriving the list 1/0 motion vector of the macroblock partition mbPartIdx, and that the list 1/0 reference index of the macroblock partition mbPartIdx is inferred from base layer.

Table 10, shown below, also includes sub-block level syntax elements:

TABLE 10
sub_mb_pred_in_{—} mfc _extension( mb_type )

| sub_mb_pred_in_{—} mfc _extension( mb_type ) { | C | Descriptor |
|---|---|---|
| for( mbPartIdx = 0; mbPartIdx < 4; mbPartIdx++ ) { | | |
| mbPart_texture_prediction_flag [ mbPartIdx ] | 2 | u(1)\| |
| | | ae(v) |
| if(!texture_prediction_flag[ mbPartIdx ]) | | |
| sub_mb_type[ mbPartIdx ] | 2 | ue(v)\| |
| | | ae(v) |
| } | | |
| for( mbPartIdx = 0; mbPartIdx < 4; mbPartIdx++ ) | | |
| if(!mbPart_texture_prediction_flag [ | | |
| mbPartIdx ] && | | |
| SubMbPredMode( sub_mb_type[ | | |
| mbPartIdx ] ) != Direct && | | |
| SubMbPredMode( sub_mb_type[ | | |
| mbPartIdx ] ) != Pred_L1 ) | | |
| motion_prediction_flag_l0[ mbPartIdx ] | 2 | u(1)\| |
| | | ae(v) |
| for( mbPartIdx = 0; mbPartIdx < 4; mbPartIdx++ ) | | |
| if(!mbPart_texture_prediction_flag [ | | |
| mbPartIdx ] && | | |
| SubMbPredMode( sub_mb_type[ | | |
| mbPartIdx ] ) != Direct&& | | |
| SubMbPredMode( sub_mb_type[ | | |
| mbPartIdx ] ) != Pred_L0) | | |
| motion_prediction_flag_l1[ mbPartIdx ] | 2 | u(1)\| |
| | | ae(v) |
| for( mbPartIdx = 0; mbPartIdx < 4; mbPartIdx++ ) | | |
| if(! mbPart_texture_prediction_flag [ mbPartIdx ] | | |
| !motion_prediction_flag_l0[ mbPartIdx ] && | | |
| && ( num_ref_idx_l0_active_minus1 > 0 \|\| | | |
| mb_field_decoding_flag ) && mb_type != | | |
| P_8×8ref0 && sub_mb_type[ mbPartIdx ] != | | |
| B_Direct_8×8 | | |
| &&SubMbPredMode( sub_mb_type[ | | |
| mbPartIdx ] ) != Pred_L1))) | | |
| ref idx_l0[ mbPartIdx ] | 2 | te(v)\| |
| | | ae(v) |
| for( mbPartIdx = 0; mbPartIdx < 4; mbPartIdx++ ) | | |
| if(! mbPart_texture_prediction_flag [ mbPartIdx ] | | |
| !motion_prediction_flag_l1[ mbPartIdx ] && | | |
| && (num_ref_idx_l1_active_minus1 > 0 \|\| | | |
| mb_field_decoding_flag) && | | |
| sub_mb_type[ mbPartIdx ] != | | |
| B_Direct_8×8 && | | |
| SubMbPredMode( sub_mb_type[ | | |
| mbPartIdx ] ) != Pred_L0 ))) | | |
| ref_idx_l1[ mbPartIdx ] | 2 | te(v)\| |
| | | ae(v) |
| for( mbPartIdx = 0; mbPartIdx < 4; mbPartIdx++ ) | | |
| if( ! mbPart_texture_prediction_flag [ mbPartIdx ] | | |
| && sub_mb_type[ mbPartIdx ] != | | |
| B_Direct_8×8 && | | |
| SubMbPredMode( sub_mb_type[ | | |
| mbPartIdx ] ) != Pred_L1) | | |
| for( subMbPartIdx = 0; | | |
| subMbPartIdx < | | |
| NumSubMbPart( sub_mb_type[ mbPartIdx ] ); | | |
| subMbPartIdx++) | | |
| for( compIdx = 0; compIdx < 2; compIdx++ ) | | |
| mvd_l0[ mbPartIdx ][ subMbPartIdx ][ | 2 | se(v)\| |
| compIdx ] | | ae(v) |
| for( mbPartIdx = 0; mbPartIdx < 4; mbPartIdx++ ) | | |
| if( ! mbPart_texture_prediction_flag [ mbPartIdx ] | | |
| && sub_mb_type[ mbPartIdx ] != | | |
| B_Direct_8×8 && | | |
| SubMbPredMode( sub_mb_type[ | | |
| mbPartIdx ] ) != Pred_L0) | | |
| for( subMbPartIdx = 0; | | |
| subMbPartIdx < | | |
| NumSubMbPart( sub_mb_type[ mbPartIdx ] ); | | |
| subMbPartIdx++) | | |
| for( compIdx = 0; compIdx < 2; compIdx++ ) | | |
| mvd_l1[ mbPartIdx ][ subMbPartIdx ][ | 2 | se(v)\| |
| compIdx ] | | ae(v) |
| } | | |

In the example shown in Table 10, video encoder 20 may set mbPart_texture_prediction_flag[mbPartIdx] equal to 1 to indicate that inter-layer textural prediction is invoked for the corresponding partition mbPartIdx. Video encoder 20 may set mbPart_texture_prediction_flag equal to 0 to indicate that no inter layer textural prediction is invoked for the partition mbPartIdx.

Video encoder 20 may set motion_prediction_flag_{—}11/0[mbPartIdx] equal to 1 to indicate that an alternative motion vector prediction process, which uses the motion vector of the base layer as reference, is used for deriving the list 1/0 motion vector of the macroblock partition mbPartIdx, and that the list 1/0 reference index of the macroblock partition mbPartIdx is inferred from base layer.

Video encoder 20 may not set a motion_prediction_flag_{—}11/0[mbPartIdx] flag (e.g., no flag is present) to indicate that no inter layer motion prediction is used for the macroblock partition mbPartIdx.

According to some aspects of the disclosure, video encoder 20 may enable or disable the mb_base_texture_flag, mbPart_texture_prediction_flag and motion_prediction_flag_{—}11/0 at the slice header level. For example, when all blocks in a slice have the same characteristics, signaling these characteristics at the slice level, rather than at the block level, may provide a relative bit savings.

In this manner, FIG. 2A is a block diagram illustrating an example of video encoder 20 that may implement techniques for producing a scalable multi-view bitstream having a base layer that includes two reduced resolution pictures corresponding to two views of a scene (e.g., left eye view and right eye view), as well as and two additional enhancement layers. A first enhancement layer may include full resolution pictures of one of the views of the base layer, while a second enhancement layer may include full resolution pictures of the other respective view of the base layer.

Again, it should be understood that certain components of FIG. 2A may be shown and described with respect to a single component for conceptual purposes, but may include one or more functional units. For example, as described in greater detail with respect to FIG. 2B, motion estimation/disparity unit 42 may be comprised of separate units for performing motion estimation and motion disparity calculations.

FIG. 2B is a block diagram illustrating another example of a video encoder that may implement techniques for producing a scalable multi-view bitstream having a base layer and two enhancement layers. As noted above, certain components of video encoder 20 may be shown and described with respect to a single component, but may include more than one discrete and/or integrated units. Moreover, certain components of video encoder 20 may be highly integrated, or incorporated into the same physical component, but illustrated separately for conceptual purposes. Thus, the example shown in FIG. 2B may include many of the same components as video encoder 20 shown in FIG. 2A, but shown in an alternative arrangement to conceptually illustrate the encoding of three layers, e.g., a base layer 142, a first enhancement layer 84, and a second enhancement layer 86.

The example shown in FIG. 2B illustrates video encoder 20 producing a scalable multi-view bitstream that includes three layers. As described above, each of the layers may include a series of frames that make up multimedia content. According to aspects of the disclosure, the three layers include a base layer 82, a first enhancement layer 84, and a second enhancement layer 86. In some examples, a frame of the base layer 142 may include two side-by-side packed reduced resolution pictures (e.g., a left eye view (“B1”) and a right eye view (“B2”)). The first enhancement layer may include a full resolution picture of the left eye view of the base layer (“E1”), and the second enhancement layer may include a full resolution picture of the right eye view of the base layer (“E2”). The base layer arrangement and sequence of enhancement layers shown in FIG. 2B, however, is provided as merely one example. In another example, the base layer 82 may include reduced resolution pictures in alternative packing arrangements (e.g., top-bottom, row interleaved, column interleaved, checkerboard, and the like). Moreover, the first enhancement layer may include full resolution pictures of the right eye view, while the second enhancement layer may include full resolution pictures of the left eye view.

In the example shown in FIG. 2B, video encoder 20 includes three intra-prediction units 46 and three motion estimation/motion compensation units 90 (e.g., which may be configured similarly to, or the same as, a combined motion estimation/disparity unit 42 and motion compensation unit 44 shown in FIG. 2A), with each layer 82-86 having an associated intra-prediction unit 46 and motion estimation/compensation unit 90. In addition, the first enhancement layer 84 and the second enhancement layer 86 are each associated with inter-layer prediction units (grouped by dashed line 98) including an inter-layer texture prediction unit 100 and an inter-layer motion prediction unit 102, as well as an inter-view prediction unit 100. The remaining components of FIG. 2B may be configured similarly to the components shown in FIG. 2A. That is, summers 50 and reference frame store 64 may be similarly configured in both representations, while transform and quantization unit 114 of FIG. 2B may be configured similarly to a combined transform unit 52 and quantization unit 54 shown in FIG. 2A. In addition, inverse quantization/inverse transform unit/reconstruction/deblocking unit 122 of FIG. 2B may be configured similarly to a combined inverse quantization unit 58 and inverse transform unit 60 shown in FIG. 2A. Mode select unit 40 is represented in FIG. 2B as a switch that toggles between each of the prediction units, may select one of the coding modes, intra-, inter-, inter-layer motion, inter-layer texture, or inter-view, e.g., based on error results.

In general, video encoder 20 may encode the base layer 82 using the intra- or inter-coding methods described above with respect to FIG. 2A. For example, video encoder 20 may intra-code the reduced resolution pictures included in the base layer 82 using intra-prediction unit 46. Video encoder 20 may inter-code the reduced resolution pictures included in the base layer 82 using motion estimation/compensation unit 90 (e.g., which may be configured similarly to, or the same as, a combined motion estimation/disparity unit 42 and motion compensation unit 44 shown in FIG. 2A). In addition, video encoder 20 may intra-code the first enhancement layer 84 or the second enhancement layer using an intra-prediction unit 46, or inter-code the first enhancement layer 84 or the second enhancement layer 86 using an motion compensation estimation/compensation unit 90.

According to aspects of the disclosure, video encoder 20 may also implement certain other inter-view or inter-layer coding methods to encode the first enhancement layer 84 and the second enhancement layer 86. For example, video encoder 20 may use inter-layer prediction units (grouped by dashed line 98) to encode the first enhancement layer 84 and the second enhancement layer 86. For example, according to the example in which the first enhancement layer 84 includes full resolution pictures of the left eye view, video encoder 20 may use inter-layer prediction units 98 to inter-layer predict the first enhancement layer 84 from the reduced resolution pictures of the left eye view of the base layer (e.g., B1). Moreover, video encoder 20 may use inter-layer prediction units 98 to inter-layer predict the second enhancement layer 86 from the reduced resolution pictures of the right eye view of the base layer (e.g., B2). In the example shown in FIG. 2B, the inter-layer prediction units 98 may receive data (e.g., motion vector data, texture data, and the like) from the motion estimation/compensation unit 90 associated with the base layer 82.

In the example shown in FIG. 2B, the inter-layer prediction units 98 include an inter-layer texture prediction unit 100 for inter-layer texture predicting the first enhancement frame 84 and the second enhancement frame 86, as well as an inter-layer motion prediction unit 102 for inter-layer motion predicting the first enhancement frame 84 and the second enhancement frame 86.

Video encoder 20 may also include inter-view prediction units 106 to inter-view predict the first enhancement layer 84 and the second enhancement layer 86. According to some examples, video encoder 20 may inter-view predict the first enhancement layer 84 (e.g., full resolution pictures of the left eye view) from the reduced resolution pictures of the right eye view of the base layer (B2). Similarly, video encoder 20 may inter-view predict the second enhancement layer 86 (e.g., full resolution pictures of the right eye view) from the reduced resolution pictures of the left eye view of the base layer (B1). Moreover, according to some examples, video encoder 20 may also inter-view predict the second enhancement layer 86 based on the first enhancement layer 84.

Following transformation and quantization of residual transform coefficients, as performed by transform and quantization unit 114, video encoder 20 may perform entropy coding and multiplexing of the quantized residual transform coefficients with entropy coding and multiplexing unit 118. That is, entropy coding and multiplexing unit 118 may code the quantized transform coefficients, e.g., perform content adaptive variable length coding (CAVLC), context adaptive binary arithmetic coding (CABAC), or another entropy coding technique (as described with respect to FIG. 2A). In addition, entropy coding and multiplexing unit 118 may generate syntax information such as coded block pattern (CBP) values, macroblock type, coding mode, maximum macroblock size for a coded unit (such as a frame, slice, macroblock, or sequence), or the like. The entropy coding and multiplexing unit 118 may format this compressed video data into so-called “network abstraction layer units” or NAL units. Each NAL unit includes a header that identifies a type of data stored to the NAL unit. According to some aspects of the disclosure, as described with respect to FIG. 2A above, the video encoder 20 may use a different NAL format for the base layer 82 than for the first and second enhancement layers 84, 86.

Again, while certain components shown in FIG. 2B may be represented as distinct units, it should be understood that certain components of video encoder 20 may be highly integrated, or incorporated into the same physical component. Accordingly, as one example, while FIG. 2B includes three discrete intra-prediction units 46, video encoder 20 may use the same physical component to perform intra-prediction.

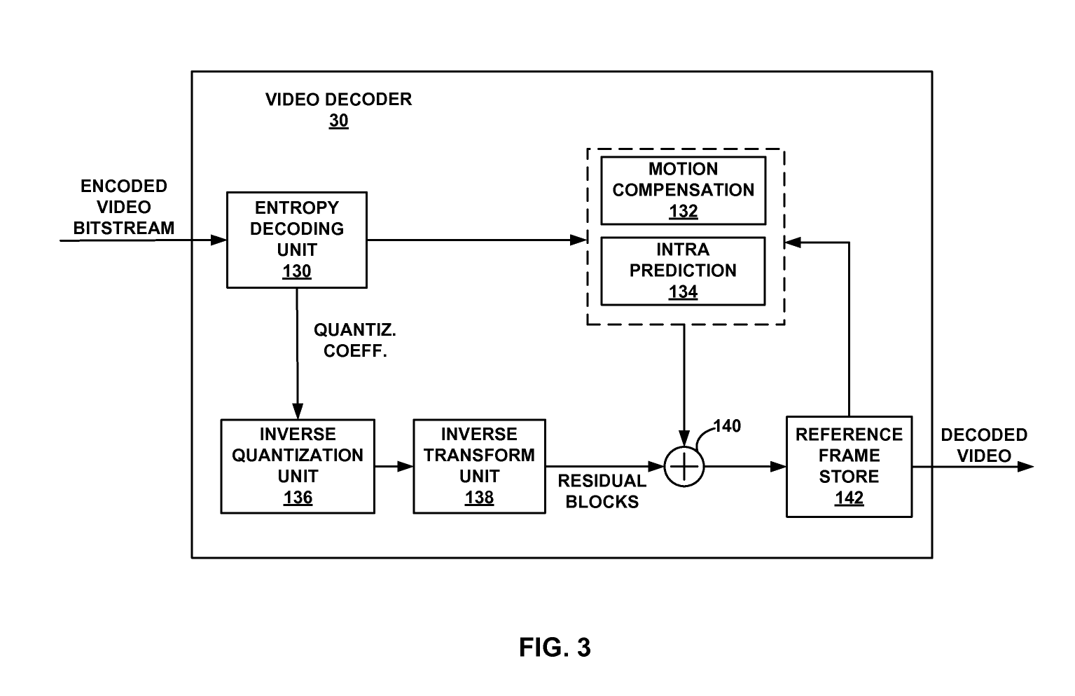

FIG. 3 is a block diagram illustrating an example of video decoder 30, which decodes an encoded video sequence. In the example of FIG. 3, video decoder 30 includes an entropy decoding unit 130, motion compensation unit 132, intra prediction unit 134, inverse quantization unit 136, inverse transformation unit 138, reference frame store 142 and summer 140. Video decoder 30 may, in some examples, perform a decoding pass generally reciprocal to the encoding pass described with respect to video encoder 20 (FIGS. 2A and 2B).

In particular, video decoder 30 may be configured to receive a scalable multi-view bitstream that includes a base layer, a first enhancement layer, and a second enhancement layer. Video decoder 30 may receive information indicative of a frame packing arrangement for the base layer, the order of the enhancement layers, as well as other information for properly decoding the scalable multi-view bitstream. For example, video decoder 30 may be configured to interpret “multi-view frame compatible” (MFC) SPS and SEI messages. Video decoder 30 may also be configured to determine whether to decode all three layers of the multi-view bitstream, or only a subset of the layers (e.g., the base layer and a first enhancement layer). This determination may be based on whether video display 32 (FIG. 1) is able to display three-dimensional video data, whether video decoder 30 has the capability to decode multiple views (and upsample a reduced resolution view) of a particular bitrate and/or framerate, or other factors regarding video decoder 30 and/or video display 32.

When destination device 14 is not able to decode and/or display three-dimensional video data, video decoder 30 may unpack the received base layer into constituent reduced resolution encoded pictures, then discard one of the reduced resolution encoded pictures. Thus, video decoder 30 may elect to only decode half of the base layer (e.g., pictures of the left eye view). In addition, video decoder 30 may elect to decode only one of the enhancement layers. That is, video decoder 30 may elect to decode the enhancement layer corresponding to the retained reduced resolution pictures of the base frame, while discarding the enhancement layer corresponding to the discarded pictures of the base frame. By retaining one of the enhancement layers, video decoder 30 may be able to reduce error associated with upsampling or interpolating the retained pictures of the base layer.

When destination device 14 is capable of decoding and displaying three-dimensional video data, video decoder 30 may unpack the received base layer into constituent reduced resolution encoded pictures, and decode each of the reduced resolution pictures. According to some examples, video decoder 30 may also decode one or both of the enhancement layers, depending on the capability of the video decoder 30 and/or video display 32. By retaining one or both of the enhancement layers, video decoder 30 can reduce error associated with upsampling or interpolating the pictures of the base layer. Again, the layers decoded by decoder 30 may depend on the capability of the video decoder 30 and/or destination device 14 and/or communication channel 16 (FIG. 1).

Video decoder 30 may retrieve displacement vectors for inter-view encoded pictures, or motion vectors for inter- or inter-layer encoded pictures, e.g., the two reduced resolution pictures of the base layer and the two full resolution pictures of the enhancement layer. Video decoder 30 may use the displacement or motion vectors to retrieve a prediction block to decode a block of the pictures. In some examples, after decoding the reduced resolution pictures of the base layer, video decoder 30 may upsample the decoded pictures to the same resolution as the enhancement layer pictures.

Motion compensation unit 132 may generate prediction data based on motion vectors received from entropy decoding unit 130. Motion compensation unit 132 may use motion vectors received in the bitstream to identify a prediction block in reference frames in reference frame store 142. Intra prediction unit 134 may use intra prediction modes received in the bitstream to form a prediction block from spatially adjacent blocks. Inverse quantization unit 136 inverse quantizes, i.e., de-quantizes, the quantized block coefficients provided in the bitstream and decoded by entropy decoding unit 130. The inverse quantization process may include a conventional process, e.g., as defined by the H.264 decoding standard. The inverse quantization process may also include use of a quantization parameter QP_{Y} calculated by encoder 20 for each macroblock to determine a degree of quantization and, likewise, a degree of inverse quantization that should be applied.

Inverse transform unit 58 applies an inverse transform, e.g., an inverse DCT, an inverse integer transform, or a conceptually similar inverse transform process, to the transform coefficients in order to produce residual blocks in the pixel domain. Motion compensation unit 132 produces motion compensated blocks, possibly performing interpolation based on interpolation filters. Identifiers for interpolation filters to be used for motion estimation with sub-pixel precision may be included in the syntax elements. Motion compensation unit 132 may use interpolation filters as used by video encoder 20 during encoding of the video block to calculate interpolated values for sub-integer pixels of a reference block. Motion compensation unit 132 may determine the interpolation filters used by video encoder 20 according to received syntax information and use the interpolation filters to produce predictive blocks.

Motion compensation unit 132 uses some of the syntax information to determine sizes of macroblocks used to encode frame(s) of the encoded video sequence, partition information that describes how each macroblock of a frame of the encoded video sequence is partitioned, modes indicating how each partition is encoded, one or more reference frames (or lists) for each inter-encoded macroblock or partition, and other information to decode the encoded video sequence.

Summer 140 sums the residual blocks with the corresponding prediction blocks generated by motion compensation unit 132 or intra-prediction unit to form decoded blocks. If desired, a deblocking filter may also be applied to filter the decoded blocks in order to remove blockiness artifacts. The decoded video blocks are then stored in reference frame store 142, which provides reference blocks for subsequent motion compensation and also produces decoded video for presentation on a display device (such as display device 32 of FIG. 1).

According to some aspects of the disclosure, video decoder 30 may manage decoded pictures, e.g., decoded pictures stored in reference frame store 142, separately for each layer. In some examples, video decoder 30 manages decoded pictures separately for each layer according to the H.264/AVC specification. Video decoder 30 may remove any upsampled decoded pictures, e.g., decoded pictures from the base layer and upsampled for enhancement layer prediction purposes, after video decoder 30 has decoded the corresponding the corresponding enhancement layer.

In an example, video decoder 30 may receive an encoded scalable multi-view bitstream having a base layer that includes reduced resolution pictures of a left eye view and a right eye view, as well as a first enhancement layer that includes full resolution pictures of the left eye view of the base frame. In this example, video decoder 30 may decode the reduced resolution pictures of the left eye view included in the base layer, and upsample the reduced resolution pictures to inter-layer predict the first enhancement layer. That is, video decoder 30 may upsample the reduced resolution pictures of the base layer prior to decoding the first enhancement layer. Upon decoding the first enhancement layer, video decoder 30 may then remove the upsampled pictures of the left eye view (e.g., from the base layer) from the reference frame store 142.

Video decoder 30 may be configured to manage decoded pictures according to received flags. For example, certain flags may be provided with received encoded video data that identify which pictures of the base layer need to be upsampled for prediction purposes. According to one example, if video decoder 30 receives an inter_view_frame_{—}0_flag, an inter_layer_frame_{—}0_flag, or an inter_component_frame_{—}0_flag that is equal to one (“1”), video decoder 30 can identify that the frame 0 part, that is, the portion of the base layer corresponding to view 0 should be upsampled. If, on the other hand, video decoder receives an inter_view_frame_{—}1_flag, an inter_layer_frame_{—}1_flag, or an inter_component_frame_{—}1_flag that is equal to one (“1”), video decoder 30 can identify that the frame 1 part, that is, the portion of the base layer corresponding to view 1 should be upsampled.

According to some aspects of the disclosure, video decoder 30 may be configured to extract and decode sub-bitstreams. That is, for example, video decoder 30 may be able to decode 30 the scalable multi-view bitstream using a variety of operation points. In some examples, video decoder 30 may extract a frame packed sub-bitstream (e.g., packed according to the H.264/AVC specification) corresponding to the base layer. Video decoder 30 may also decode a single-view operation point. Video decoder 30 may also decode an asymmetric operation point.

The decoder 30 may receive syntax or instructions from an encoder, such as video encoder 20 shown in FIGS. 2A and 2B, that identify an operation point. For example, video decoder 30 may receive a variable twoFullViewsFlag (when present), a variable twoHalfViewsFlag (when present), a variable tIdTarget (when present), and a variable LeftViewFlag (when present). In this example, video decoder 30 may apply the following operations, using the input variables described above, to derive the sub-bitstream:
1. Mark view 0, 1 and 2 as a target view.
2. When twoFullViewsFlag is false
   a. Mark view 2 as a non-target view, if both LeftViewFlag and left_view_enhance_first are 1 or 0 ((LeftViewFlag+left_view_enhance_first)%2==0);
   b. Otherwise, (LeftViewFlag+left_view_enhance_first)%2==1),
      i. If full_left_right_dependent_flag is 1, mark view 1 as a non-target view.
3. Mark all VCL NAL units and filler data NAL units for which any of the following conditions is true as “to be removed from the bitstream”:
   a. temporal_id is greater than tIdTarget,
   b. nal_ref_idc is equal to 0 and inter_component_flag is equal to 0 (or all the following flags are equal to 0: inter_view_frame_{—}0_flag, inter_view_frame_{—}1_flag, inter_layer_frame_{—}0_flag, inter_layer_frame_{—}1_flag, inter_view_flag, and inter_layer_flag).
   c. The view with a view_id equal to (2-second_view_flag) is a non-target view.
4. Remove all access units for which all VCL NAL units are marked as “to be removed from the bitstream”.
5. Remove all VCL NAL units and filler data NAL units that are marked as “to be removed from the bitstream”.
6. When twoHalfViewsFlag is 1, remove the following NAL units:
   a. all NAL units with nal_unit_type equal to NEWTYPE1 or NEWTYPE2.
   b. all NAL units with that contain the SPS mfc extension (probably with a new type) and SEI messages defined in this amendment (with different SEI types).

In this example, when twoFullViewsFlag is not present as input to this subclause, twoFullViewsFlag is inferred to be equal to 1. When twoHalfViewsFlag is not present as input to this subclause, twoHalfViewsFlag is inferred to be equal to 0. When tIdTarget is not present as input to this subclause, tIdTarget is inferred to be equal to 7. When LeftViewFlag is not present as input of this subclause, LeftViewFlag is inferred to be true.

While described with respect to video decoder 30, in other examples, the sub-bitstream extraction may be performed by another device or component of a destination device (e.g., destination device 14 shown in FIG. 1). For example, according to some aspects of the disclosure, sub-bitstreams may be identified as attributes, e.g., as attributes that are included as part of a manifest of a video service. In this example, the manifest may be transmitted before a client (e.g., destination device 14) starts playing any specific video representation, such that the client may use the attributes to select an operation point. That is, the client may select to receive the base layer only, the base layer and one enhancement layer, or the base layer and both enhancement layers.

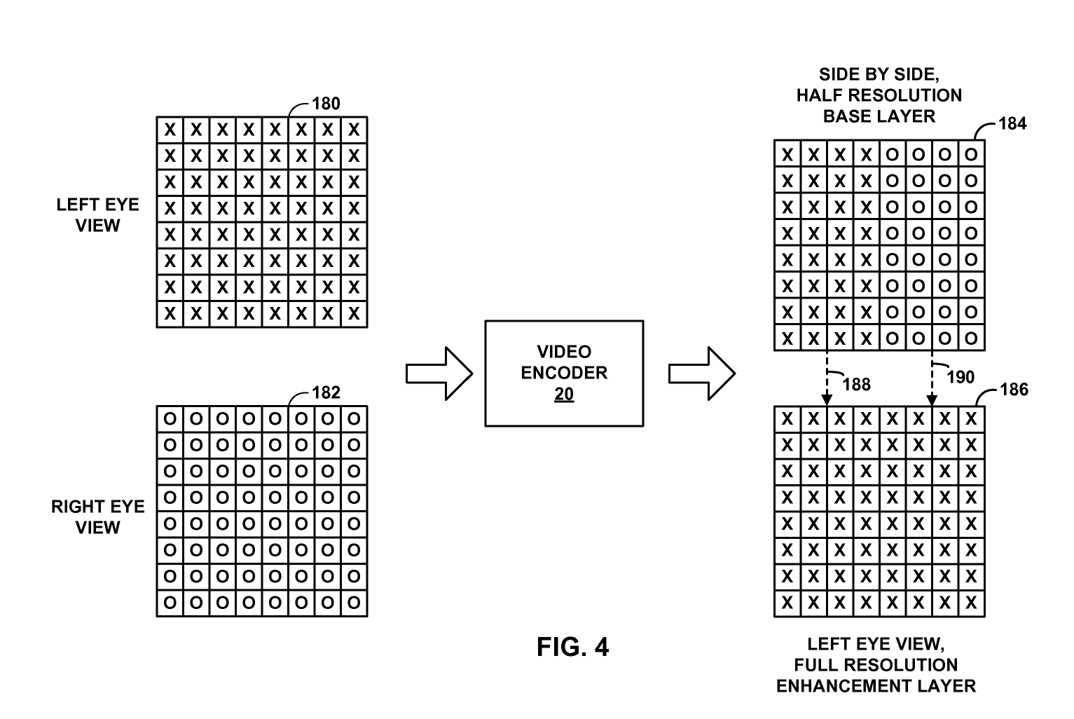

FIG. 4 is a conceptual diagram illustrating a left eye view picture 180 and a right eye view picture 182 combined by video encoder 20 to form a packed frame of a base layer 184 (“base layer frame 184”) having reduced resolution pictures corresponding to the left eye view picture 180 and right eye view picture 182. Video encoder 20 also forms a frame of an enhancement layer 186 (“enhancement layer frame 186”) that corresponds to the left eye view picture 180. In this example, video encoder 20 receives picture 180, including raw video data of a left eye view of a scene, and picture 182, including raw video data of a right eye view of the scene. The left eye view may correspond to view 0, while the right eye view may correspond to view 1. Pictures 180, 182 may correspond to two pictures of the same temporal instance. For example, pictures 180, 182 may have been captured by cameras at substantially the same time.

In the example of FIG. 4, samples (e.g., pixels) of picture 180 are indicated with X's, while samples of picture 182 are indicated with O's. As shown, video encoder 20 may downsample picture 180, downsample picture 182, and combine the pictures to form base layer frame 184, which video encoder 20 may encode. In this example, video encoder 20 arranges the downsampled picture 180 and the downsampled picture 182 in base layer frame 184 in a side-by-side arrangement. To downsample pictures 180 and 182 and arrange the downsampled picture in a side-by-side base layer frame 184, video encoder 20 may decimate alternate columns of each picture 180 and 182. As another example, video encoder 20 may entirely remove alternate columns of pictures 180 and 182 to produce downsampled versions of pictures 180 and 182.

In other examples, however, video encoder 20 may pack the downsampled picture 180 and the downsampled picture 182 in other arrangements. For example, video encoder 20 may alternate columns of pictures 180 and 182. In another example, video encoder 20 may decimate or remove rows of pictures 180 and 182 and arrange the downsampled pictures in a top-bottom or alternating arrangement. In still another example, video encoder 20 may quincunx (checkerboard) sample pictures 180 and 182 and arrange the samples in base layer frame 184.

In addition to the base layer frame 184, video encoder 20 may encode a full resolution enhancement layer frame 186 that corresponds to the picture of the left eye view of the base layer frame 184 (e.g., view 0). According to some aspects of the disclosure, video encoder 20 may encode enhancement layer frame 186 using inter-layer prediction (represented by dashed line 188), as previously described. That is, video encoder 20 may encode enhancement layer frame 186 using inter-layer prediction with inter-layer texture prediction, or inter-layer prediction with inter-layer motion prediction. Additionally or alternatively, video encoder 20 may encode enhancement layer frame 186 using inter-view prediction (represented by dashed line 190), as previously described.

In the illustration of FIG. 4, base layer frame 184 includes X's corresponding to data from picture 180 and O's corresponding to data from picture 182. However, it should be understood that the data of base layer frame 184 corresponding to pictures 180 and 182 will not necessarily align exactly with data of pictures 180 and 182 following downsampling. Likewise, following encoding, the data of the pictures in base layer frame 184 will likely be different than the data of pictures 180, 182. Accordingly, it should not be assumed that the data of one X or O in base layer frame 184 is necessarily identical to a corresponding X or O in pictures 180, 182, or that the X or O in base layer frame 184 is the same resolution as the X or O in pictures 180, 182.

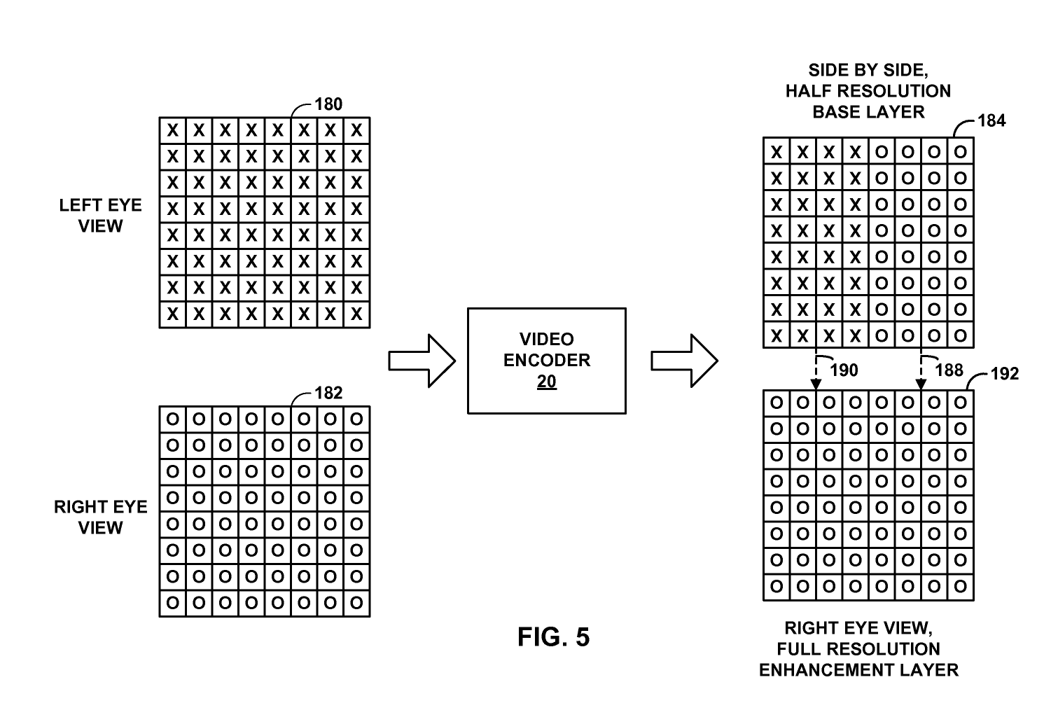

FIG. 5 is a conceptual diagram illustrating a left eye view picture 180 and a right eye view picture 182 combined by video encoder 20 to form a frame of a base layer 184 (“base layer frame 184”) and a frame of an enhancement layer 192 (“enhancement layer frame 192”) that corresponds to the right eye view picture 182. In this example, video encoder 20 receives picture 180, including raw video data of a left eye view of a scene, and picture 182, including raw video data of a right eye view of the scene. The left eye view may correspond to view 0, while the right eye view may correspond to view 1. Pictures 180, 182 may correspond to two pictures of the same temporal instance. For example, pictures 180, 182 may have been captured by cameras at substantially the same time.

Similar to the example shown in FIG. 4, the example shown in FIG. 5 includes samples (e.g., pixels) of picture 180 that are indicated with X's, and samples of picture 182 that are indicated with O's. As shown, video encoder 20 may downsample and encode picture 180, downsample and encode picture 182, and combine the pictures to form base layer frame 184 in the same manner as that shown in FIG. 4.

In addition to the base layer frame 184, video encoder 20 may encode a full resolution enhancement layer frame 192 that corresponds to the picture of the right eye view of the base layer 184 (e.g., view 1). According to some aspects of the disclosure, video encoder 20 may encode enhancement layer frame 192 using inter-layer prediction (represented by dashed line 188), as previously described. That is, video encoder 20 may encode enhancement layer frame 192 using inter-layer prediction with inter-layer texture prediction, or inter-layer prediction with inter-layer motion prediction. Additionally or alternatively, video encoder 20 may encode enhancement layer frame 192 using inter-view prediction (represented by dashed line 190), as previously described.

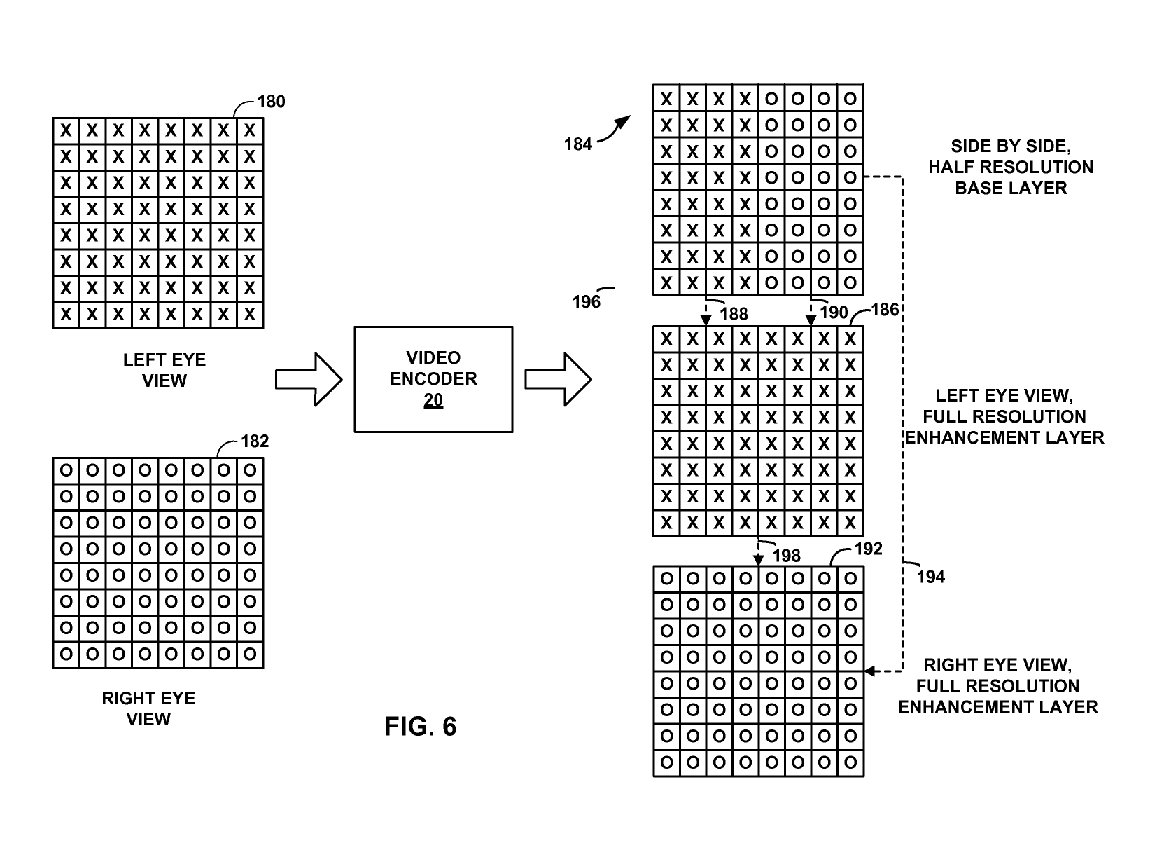

FIG. 6 is a conceptual diagram illustrating a left eye view picture 180 and a right eye view picture 182 combined by video encoder 20 to form a frame of a base layer 184 (“base layer frame 184), a frame of a first enhancement layer (“first enhancement layer frame 186”) that includes a full resolution picture of the left eye view 180, and a frame of a second enhancement layer (“second enhancement layer frame 192”) that includes a full resolution picture of right eye view 182. In this example, video encoder 20 receives picture 180, including raw video data of a left eye view of a scene, and picture 182, including raw video data of a right eye view of the scene. The left eye view may correspond to view 0, while the right eye view may correspond to view 1. Pictures 180, 182 may correspond to two pictures of the same temporal instance. For example, pictures 180, 182 may have been captured by cameras at substantially the same time.

Similar to the examples shown in FIGS. 4 and 5, the example shown in FIG. 6 includes samples (e.g., pixels) of picture 180 that are indicated with X's, and samples of picture 182 that are indicated with O's. As shown, video encoder 20 may downsample and encode picture 180, downsample and encode picture 182, and combine the pictures to form base layer frame 184 in the same manner as that shown in FIGS. 4 and 5.

In addition to the base layer frame 184, video encoder 20 may encode the first enhancement layer frame 186, which corresponds to the left eye view picture of the base layer frame 184 (e.g., view 0). Video encoder 20 may also encode the second enhancement layer frame 192, which corresponds to the right eye view picture of the base layer frame 184 (e.g., view 1). The ordering of the enhancement layer frames, however, is provided merely as one example. That is, in other examples, video encoder 20 may encode a first enhancement layer frame that corresponds to the picture of the right eye view of the base layer frame 184, and a second enhancement layer frame that corresponds to the picture of the left eye view of the base layer frame 184.

In the example shown in FIG. 6, video encoder 20 may encode the first enhancement layer frame 186 using inter-layer prediction (represented by dashed line 188) based on the base layer frame 184, as previously described. That is, video encoder 20 may encode the first enhancement layer frame 186 using inter-layer prediction with inter-layer texture prediction, or inter-layer prediction with inter-layer motion prediction based on the base layer frame 184. Additionally or alternatively, video encoder 20 may encode the first enhancement layer frame 186 using inter-view prediction (represented by dashed line 190) based on the base layer frame 184, as previously described.

Video encoder 20 may also encode the second enhancement layer frame 192 using inter-layer prediction (represented by dashed line 194) based on the base layer frame 184, as described above. That is, video encoder 20 may encode the second enhancement layer frame 192 using inter-layer prediction with inter-layer texture prediction, or inter-layer prediction with inter-layer motion prediction based on the base layer frame 184.

Additionally or alternatively, video encoder 20 may encode the second enhancement layer frame 192 using inter-view prediction (represented by dashed line 190) based on the first enhancement layer frame 186.

According to aspects of the disclosure, the amount of bandwidth of the multi-view scalable bitstream dedicated to each layer, i.e., the base layer 184, the first enhancement layer 186, and the second enhancement layer 192, may vary according to the dependencies of the layer. For example, in general, the video encoder 20 may assign 50%-60% of the bandwidth of the scalable multi-view bitstream to the base layer 184. That is, the data associated with the base layer 184 makes up 50%-60% of the entire data dedicated to the bitstream. If the first enhancement layer 186 and the second enhancement layer 192 do not depend on each other (e.g., the second enhancement layer 192 does not use the first enhancement layer 186 for prediction purposes), video encoder 20 may assign approximately equal amounts of the remaining bandwidth to each of the respective enhancement layers 186, 192 (e.g., 25%-20% of the bandwidth for each respective enhancement layer 186, 192). Alternatively, if the second enhancement layer 192 is predicted from the first enhancement layer 186, the video encoder 20 may assign a relatively larger amount of bandwidth to the first enhancement layer 186. That is, video encoder 20 may assign approximately 25%-30% percent of the bandwidth to the first enhancement layer 186, and approximately 15%-20% of the bandwidth to the second enhancement layer 192.

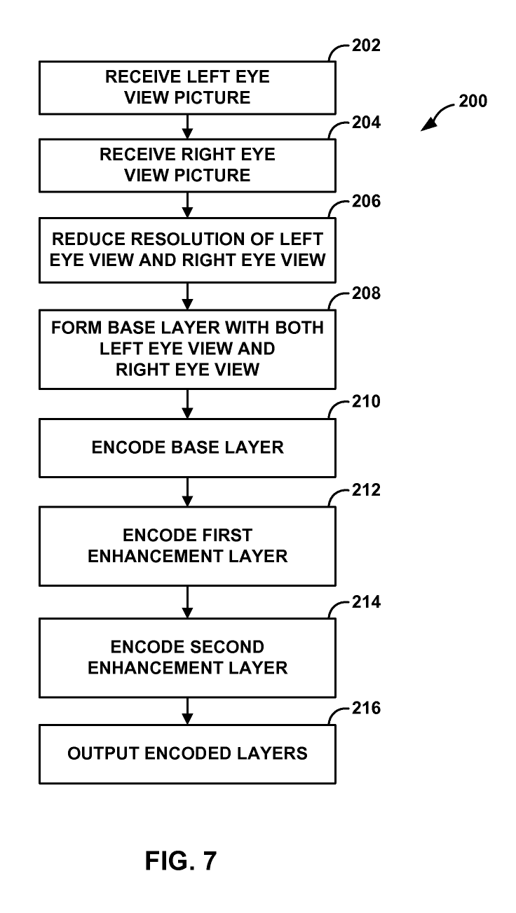

FIG. 7 is a flowchart illustrating an example method 200 for forming and encoding a scalable multi-view bitstream that includes a base layer having two reduced resolution pictures of two different views, as well as a first enhancement layer and a second enhancement layer. Although generally described with respect to the example components of FIGS. 1 and 2A-2B, it should be understood that other encoders, encoding units, and encoding devices may be configured to perform the method of FIG. 7. Moreover, the steps of the method of FIG. 7 need not necessarily be performed in the order shown in FIG. 7, and fewer, additional, or alternative steps may be performed.

In the example of FIG. 7, video encoder 20 first receives a picture of a left eye view (202), e.g., view 0. Video encoder 20 may also receive a picture of a right eye view, e.g., view 1, (204), such that the two received pictures form a stereo image pair. The left eye view and the right eye view may form a stereo view pair, also referred to as a complementary view pair. The received picture of the right eye view may correspond to the same temporal location as the received picture of the left eye view. That is, the picture of the left eye view and the picture of the right eye view may have been captured or generated at substantially the same time. Video encoder 20 may then reduce the resolution of the picture of the left eye view picture and the picture of the right eye view (206). In some examples, a preprocessing unit of video encoder 20 may receive the pictures. In some examples, the video preprocessing unit may be external to video encoder 20.

In the example of FIG. 7, video encoder 20 reduces the resolution of the picture of the left eye view and the picture of the right eye view (206). For example, video encoder 20 may subsample the received left eye view picture and the right eye view picture (e.g., using row-wise, column-wise, or quincunx (checkerboard) subsampling), decimate rows or columns of the received left eye view picture and the right eye view picture, or otherwise reduce the resolution of the received left eye view picture and right eye view picture. In some examples, video encoder 20 may produce two reduced resolution pictures having either half of the width or half of the height of the corresponding full resolution picture of the left eye view. In other examples including a video preprocessor, the video preprocessor may be configured to reduce the resolution of the right eye view picture.

Video encoder 20 may then form a base layer frame including both the downsampled left eye view picture and the downsampled right eye view picture (208). For example, video encoder 20 may form a base layer frame having a side-by-side arrangement, top-bottom arrangement, having columns of the left view picture interleaved with columns of the right view picture, having rows of the left view picture interleaved with rows of the right view picture, or in a “checkerboard” type arrangement.

Video encoder 20 may then encode the base layer frame (210). According to aspects of the disclosure, as described with respect to FIGS. 2A and 2B, video encoder 20 may intra- or inter-code the pictures of the base layer. After encoding the base layer frame, video encoder 20 may then encode a first enhancement layer frame (212). According to the example shown in FIG. 7, video encoder 20 encodes the left view picture as the first enhancement layer frame, although in other examples, video encoder 20 may encode the right view picture as the first enhancement layer frame. Video encoder 20 may intra-, inter-, inter-layer (e.g., inter-layer texture prediction or inter-layer motion prediction), or inter-view code the first enhancement layer frame. Video encoder 20 may use the corresponding reduced resolution picture of the base layer (e.g., the picture of the left eye view) as a reference for prediction purposes. If video encoder 20 encodes the first enhancement layer frame using inter-layer prediction, video encoder 20 may first upsample the left eye view picture of the base layer frame for prediction purposes. Alternatively, if video encoder 20 encodes the first enhancement layer frame using inter-view prediction, video encoder 20 may first upsample the right eye view picture of the base layer frame for prediction purposes.

After encoding the first enhancement layer frame, video encoder 20 may then encode a second enhancement layer frame (214). According to the example shown in FIG. 7, video encoder 20 encodes the right view picture as the second enhancement layer frame, although in other examples, video encoder 20 may encode the left view picture as the second enhancement layer frame. Similar to the first enhancement layer frame, video encoder 20 may intra-, inter-, inter-layer (e.g., inter-layer texture prediction or inter-layer motion prediction), or inter-view code the second enhancement layer frame. Video encoder 20 may encode the second enhancement layer frame using the corresponding picture of the base layer frame (e.g., the picture of the right eye view) as a reference for prediction purposes. For example, if video encoder 20 encodes the second enhancement layer frame using inter-layer prediction, video encoder 20 may first upsample the right eye view picture of the base layer frame for prediction purposes. Alternatively, if video encoder 20 encodes the second enhancement layer frame using inter-view prediction, video encoder 20 may first upsample the left eye view picture of the base layer frame for prediction purposes.

According to aspects of the disclosure, video encoder 20 may also (or alternatively) use the first enhancement layer frame to predict the second enhancement layer frame. That is, video encoder may inter-view encode the second enhancement layer frame using the first enhancement layer for prediction purposes.

Video encoder 20 may then output the encoded layers (216). That is, video encoder 20 may output a scalable multi-view bitstream that includes frames from the base layer, the first enhancement layer, and the second enhancement layer. According to some examples, video encoder 20, or a unit coupled to video encoder 20, may store the encoded layers to a computer-readable storage medium, broadcast the encoded layers, transmit the encoded layers via network transmission or network broadcast, or otherwise provide the encoded video data.

It should also be understood that video encoder 20 need not necessarily provide information indicating the frame packing arrangement of the base layer frame and the order in which the layers are provided for each frame of the bitstream. In some examples, video encoder 20 may provide a single set of information, e.g., SPS and SEI messages, for the entire bitstream indicating this information for each frame of the bitstream. In some examples, video encoder 20 may provide the information periodically, e.g., after each video fragment, group of pictures (GOP), video segment, every certain number of frames, or at other periodic intervals. Video encoder 20, or another unit associated with video encoder 20, may also provide the SPS and SEI messages on demand in some examples. e.g., in response to a request from a client device for the SPS or SEI message or a general request for header data of the bitstream.

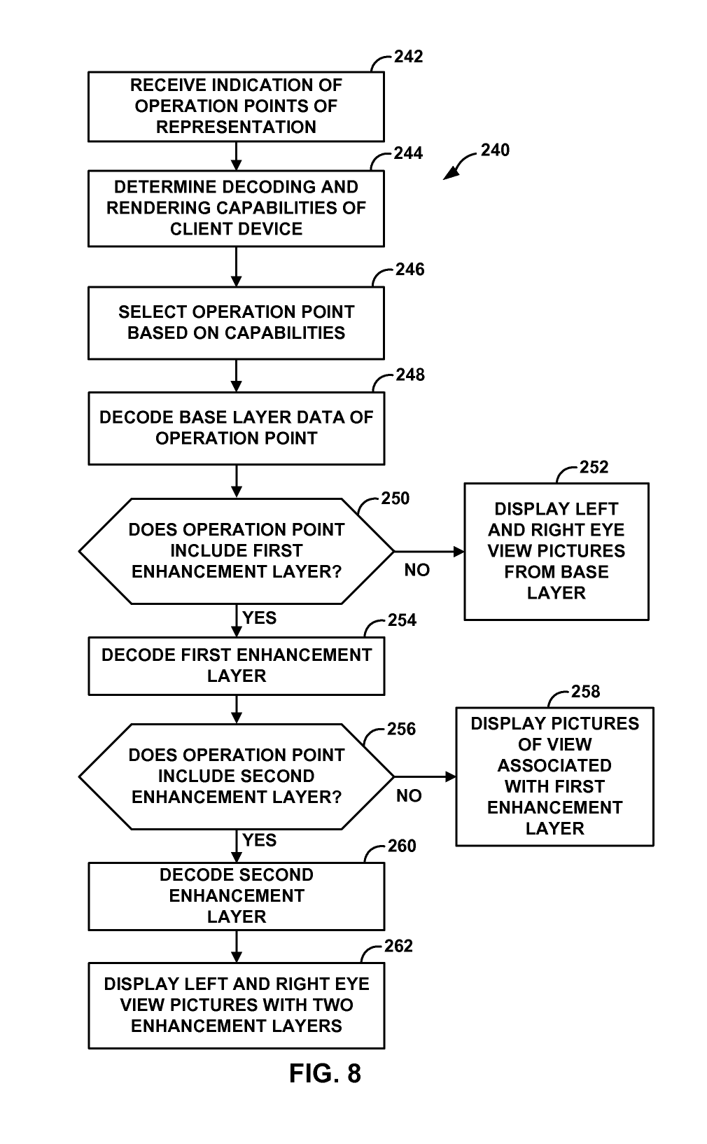

FIG. 8 is a flowchart illustrating an example method 240 for decoding a scalable multi-view bitstream having a base layer, a first enhancement layer, and a second enhancement layer. Although generally described with respect to the example components of FIGS. 1 and 3, it should be understood that other decoders, decoding units, and decoding devices may be configured to perform the method of FIG. 8. Moreover, the steps of the method of FIG. 8 need not necessarily be performed in the order shown in FIG. 8, and fewer, additional, or alternative steps may be performed.

Initially, video decoder 30 may receive an indication of potential operation points of a certain representation (242). That is, video decoder 30 may receive an indication of which layers are provided in the scalable multi-view bitstream, as well as the dependencies of the layers. For example, video decoder 30 may receive SPS, SEI, and NAL messages that provide information about the encoded video data. In some examples, video decoder 30 may have previously received an SPS message for the bitstream, prior to receiving the encoded layers, in which case video decoder 30 may have already determined the layers of the scalable multi-view bitstream prior to receiving the encoded layers. In some examples, transmission limitations, e.g., bandwidth restrictions or limitations of transmission medium, may cause the enhancement layers to become degraded or discarded such that certain operation points are unavailable.

A client device (e.g., destination device 14 of FIG. 1) including video decoder 30 may also determine its decoding and rendering capabilities (244). In some examples, video decoder 30 or the client device in which video decoder 30 is installed may not have the capability of decoding or rendering pictures for a three dimensional representation, or may not have the capability of decoding pictures for one or both of the enhancement layers. In still other examples, bandwidth availability in the network may prohibit retrieval of the base layer and one or both enhancement layers. Accordingly, the client device may select an operation point based on the decoding capabilities of video decoder 30, the rendering capabilities of the client device in which video decoder 30 is installed, and/or current network conditions (246). In some examples, the client device may be configured to reevaluate network conditions and request data for a different operation point based on the new network conditions, e.g., to retrieve more data (such as one or both enhancement layers) when available bandwidth increases, or to retrieve less data (such as only one or none of the enhancement layers) when the available bandwidth decreases.

After selecting an operation point, video decoder 30 may decode a base layer of the scalable multi-view bitstream (248). For example, video decoder 30 may decode the picture of the left eye view and the picture of the right eye view of the base layer, separate the decoded pictures, and upsample the pictures to full resolution. According to some examples, video decoder 30 may first decode the pictures of the left eye view of the base layer, followed by the pictures of the right eye view of the base layer. After video decoder 30 separates the decoded base layer into constituent pictures, e.g., the picture of the left eye view and the picture of the right eye view, video decoder 30 may store a copy of the left eye view picture and the right eye view picture for reference to decode the enhancement layers. In addition, the left eye view picture and the right eye view picture of the base layer may both be reduced resolution pictures. Accordingly, video decoder 30 may upsample the left eye view picture and the right eye view picture, e.g., by interpolating missing information to form full resolution versions of the left eye view picture and the right eye view picture.

In some examples, video decoder 30 or the device in which video decoder 30 is installed (e.g., destination device 14 shown in FIG. 1) may not have the capability of decoding one or both of the enhancement layers. In other examples, transmission limitations, e.g., bandwidth restrictions or limitations of transmission medium, may cause the enhancement layers to become degraded or discarded. In other examples, video display 32 may not have the ability to present two views, e.g., may not be 3-D capable. Accordingly, in the example shown in FIG. 8, video decoder 30 determines whether the selected operation point (of step 246) includes decoding the first enhancement layer (250).

If the video decoder 30 does not decode the first enhancement layer, or the first enhancement layer is no longer present in the bitstream, video decoder 30 may upsample (e.g., interpolate) the left and right eye view pictures of the base layer and send the upsampled representations of the left eye view and right eye view pictures, to video display 32, which may display the left and right eye view pictures simultaneously or nearly simultaneously (252). In another example, if video display 32 is not capable of displaying stereo (e.g., 3D) content, video decoder 30 or video display 32 may discard either the left eye view pictures or the right eye view pictures prior to display.

Video decoder 30 may, however, decode the first enhancement layer (254). As described with respect to FIG. 3 above, video decoder 30 may receive syntax to assist video decoder 30 in decoding the first enhancement layer. For example, video decoder 30 may determine whether intra-, inter-, inter-layer (e.g., texture or motion), or inter-view prediction was used to encode the first enhancement layer. Video decoder 30 may then decode the first enhancement layer accordingly. According to some aspects of the disclosure, video decoder 30 may upsample the corresponding picture of the base layer prior to decoding the first enhancement layer.

As described above, video decoder 30 or the device in which video decoder 30 is installed may not have the capability of decoding both of the enhancement layers, or transmission limitations may cause the second enhancement layer to become degraded or discarded. Accordingly, after decoding the first enhancement layer, video decoder 30 determines whether the selected operation point (step 246) includes decoding the second enhancement layer (256).

If the video decoder 30 does not decode the second enhancement layer, or the second enhancement layer is no longer present in the bitstream, video decoder 30 may discard the pictures of the base layer that are not associated with the first enhancement layer, and send the pictures associated with the first enhancement layer to display 32 (258). That is, for a video display 32 that is not capable of displaying stereo content, video decoder 30 or video display 32 may discard the pictures of the base layer that are not associated with the first enhancement layer prior to display. For example, if the first enhancement layer includes full resolution left eye view pictures, video decoder 30 or display 32 may discard the right eye view pictures of the base layer prior to display. Alternatively, if the first enhancement layer includes full resolution right eye view pictures, video decoder 30 or display 32 may discard the left eye view pictures of the base layer prior to display.

In another example, if the video decoder 20 does not decode the second enhancement layer, or the second enhancement layer is no longer present in the bitstream, video decoder 30 may send one upsampled picture (e.g., from the base layer) and one full resolution picture (e.g., from the enhancement layer) to display 32, which may display the left and right eye view pictures simultaneously or nearly simultaneously. That is, if the first enhancement layer corresponds to the left view picture, video decoder 30 may send the full resolution left view picture from the first enhancement layer and the upsampled right view picture from the base layer to display 32. Alternatively, if the first enhancement layer corresponds to the right view picture, video decoder 30 may send the full resolution right view picture from the first enhancement layer and the upsampled left view picture from the base layer to display 32. Display 32 may present the one full resolution picture and the one upsampled picture simultaneously or nearly simultaneously.

Video decoder 30 may, however, decode the second enhancement layer (260). As described with respect to FIG. 3 above, video decoder 30 may receive syntax to assist video decoder 30 in decoding the second enhancement layer. For example, video decoder 30 may determine whether intra-, inter-, inter-layer (e.g., texture or motion), or inter-view prediction was used to encode the second enhancement layer. Video decoder 30 may then decode the second enhancement layer accordingly. According to some aspects of the disclosure, video decoder 30 may upsample the corresponding decoded picture of the base layer prior to decoding the first enhancement layer. Alternatively, if decoder 30 determines that the second enhancement layer was predicted based on the first enhancement layer, decoder 30 may use the decoded first enhancement layer when decoding the second enhancement layer.

After decoding both the first enhancement layer (254) and the second enhancement layer (260), video decoder 30 may send both a full resolution left view picture and a full resolution right view picture from the enhancement layers to display 32. Display 32 may present the full resolution left view picture and the full resolution right view picture simultaneously or nearly simultaneously (262).

In some examples, video decoder 30 or the device in which video decoder 30 is installed (e.g., destination device 14 shown in FIG. 1) may not be capable of three-dimensional video playback. In such examples, video decoder 30 may not decode both pictures. That is, decoder 30 may simply decode the left eye view pictures of the base layer and skip (e.g., discard) the right eye view pictures of the base layer. In addition, video decoder 30 may decode only the enhancement layer that corresponds to the decoded view of the base layer. In this manner, devices may be capable of receiving and decoding a scalable multi-view bitstream whether or not the devices are capable of decoding and/or rendering three-dimensional video data.

Although generally described with respect to a video encoder and a video decoder, the techniques of this disclosure may be implemented in other devices and coding units. For example, the techniques for forming a scalable multi-view bitstream that includes a base layer, a first enhancement layer, and a second enhancement layer may be performed by a transcoder configured to receive two separate, complementary bitstreams and to transcode the two bitstreams to form a single bitstream including the base layer, the first enhancement layer, and the second enhancement layer. As another example, the techniques for disassembling a scalable multi-view bitstream may be performed by a transcoder configured to receive a bitstream including the base layer, the first enhancement layer, and the second enhancement layer and to produce two separate bitstreams corresponding to respective views of the base layer, each including encoded video data for a respective view.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

1. A method of decoding video data comprising base layer data and enhancement layer data, the method comprising:
decoding base layer data having a first resolution, wherein the base layer data comprises a reduced resolution version of a left view relative to the first resolution and a reduced resolution version of a right view relative to the first resolution;
decoding enhancement layer data having the first resolution and comprising enhancement data for exactly one of the left view and the right view, wherein the enhancement data has the first resolution, and wherein decoding the enhancement layer data comprises decoding the enhancement layer data relative to at least a portion of the base layer data; and
combining the decoded enhancement layer data with the one of the left view or the right view of the decoded base layer data to which the decoded enhancement layer corresponds.

2. The method of claim 1, wherein the enhancement layer data comprises first enhancement layer data, the method further comprising decoding, separately from the first enhancement layer data, second enhancement layer data for exactly one of the left view and right view not associated with the first enhancement layer data, wherein the second enhancement layer has the first resolution, and wherein decoding the second enhancement layer data comprises decoding the second enhancement layer data relative to at least a portion of the base layer data or at least a portion of first enhancement layer data.

3. The method of claim 2, wherein decoding the second enhancement layer data comprises retrieving inter-layer prediction data for the second enhancement layer data from an upsampled version of the view of the base layer data corresponding to the second enhancement layer, wherein the upsampled version has the first resolution.

4. The method of claim 2, wherein decoding the second enhancement layer data comprises retrieving inter-view prediction data for the second enhancement layer data from at least one of an upsampled version of the other view of the base layer having the first resolution and the first enhancement layer data.

5. The method of claim 4, further comprising decoding reference picture list construction data located in a slice header associated with the second enhancement layer that indicates whether the prediction data is associated with the upsampled version of the other view of the base layer having the first resolution or the first enhancement layer data.

6. The method of claim 1, wherein decoding the first enhancement layer data comprises retrieving inter-layer prediction data for the first enhancement layer data from an upsampled version of the view of the base layer data corresponding to the first enhancement layer, wherein the upsampled version has the first resolution.

7. The method of claim 1, wherein decoding the first enhancement layer data comprises retrieving inter-view prediction data for the first enhancement layer data from an upsampled version of the other view of the base layer data, wherein the upsampled version has the first resolution.

8. An apparatus for decoding video data comprising base layer data and enhancement layer data, the apparatus comprising a video decoder configured to:
decode base layer data having a first resolution, wherein the base layer data comprises a reduced resolution version of a left view relative to the first resolution and a reduced resolution version of a right view relative to the first resolution;
decode enhancement layer data having the first resolution and comprising enhancement data for exactly one of the left view and the right view,
wherein the enhancement data has the first resolution, and
wherein decoding the enhancement layer data comprises decoding the enhancement layer data relative to at least a portion of the base layer data; and
combine the decoded enhancement layer data with the one of the left view or the right view of the decoded base layer data to which the decoded enhancement layer corresponds.

9. The apparatus of claim 8, wherein the enhancement layer data comprises first enhancement layer data, the video decoder is further configured to decode, separately from the first enhancement layer data, second enhancement layer data for exactly one of the left view and right view not associated with the first enhancement layer data,
wherein the second enhancement layer has the first resolution, and wherein decoding the second enhancement layer data comprises decoding the second enhancement layer data relative to at least a portion of the base layer data or at least a portion of first enhancement layer data.

10. The apparatus of claim 9, wherein to decode the second enhancement layer data, the decoder is configured to retrieve inter-layer prediction data for the second enhancement layer data from an upsampled version of the view of the base layer data corresponding to the second enhancement layer, wherein the upsampled version has the first resolution.

11. The apparatus of claim 9, wherein to decode the second enhancement layer data, the decoder is configured to retrieve inter-view prediction data for the second enhancement layer data from at least one of an upsampled version of the other view of the base layer having the first resolution and the first enhancement layer data.

12. The apparatus of claim 11, wherein the video decoder is further configured to decode reference picture list construction data located in a slice header associated with the second enhancement layer that indicates whether the prediction data is associated with the upsampled version of the other view of the base layer having the first resolution or the first enhancement layer data.

13. The apparatus of claim 8, wherein to decode the first enhancement layer data the decoder is configured to retrieve inter-layer prediction data for the first enhancement layer data from an upsampled version of the view of the base layer data corresponding to the first enhancement layer, wherein the upsampled version has the first resolution.

14. The apparatus of claim 8, wherein to decode the first enhancement layer data the decoder is configured to retrieve inter-view prediction data for the first enhancement layer data from an upsampled version of the other view of the base layer data, wherein the upsampled version has the first resolution.

15. The apparatus of claim 8, wherein the apparatus comprises at least one of:
an integrated circuit;
a microprocessor; and
a wireless communication device that includes the video encoder.

16. An apparatus for decoding video data comprising base layer data and enhancement layer data, the apparatus comprising:
means for decoding base layer data having a first resolution, wherein the base layer data comprises a reduced resolution version of a left view relative to the first resolution and a reduced resolution version of a right view relative to the first resolution;
means for decoding enhancement layer data having the first resolution and comprising enhancement data for exactly one of the left view and the right view, wherein the enhancement data has the first resolution, and wherein decoding the enhancement layer data comprises decoding the enhancement layer data relative to at least a portion of the base layer data; and
means for combining the decoded enhancement layer data with the one of the left view or the right view of the decoded base layer data to which the decoded enhancement layer corresponds.

17. The apparatus of claim 16, wherein the enhancement layer data comprises first enhancement layer data, the apparatus further comprising a means for decoding, separately from the first enhancement layer data, second enhancement layer data for exactly one of the left view and right view not associated with the first enhancement layer data, wherein the second enhancement layer has the first resolution, and wherein decoding the second enhancement layer data comprises decoding the second enhancement layer data relative to at least a portion of the base layer data or at least a portion of first enhancement layer data.

18. A computer program product comprising a computer-readable storage medium having stored thereon instructions that, when executed, cause a processor of a device for decoding video data having base layer data and enhancement layer data to:
decode base layer data having a first resolution, wherein the base layer data comprises a reduced resolution version of a left view relative to the first resolution and a reduced resolution version of a right view relative to the first resolution;
decode enhancement layer data having the first resolution and comprising enhancement data for exactly one of the left view and the right view, wherein the enhancement data has the first resolution, and wherein decoding the enhancement layer data comprises decoding the enhancement layer data relative to at least a portion of the base layer data; and
combine the decoded enhancement layer data with the one of the left view or the right view of the decoded base layer data to which the decoded enhancement layer corresponds.

19. The computer program product of claim 18, wherein the enhancement layer data comprises first enhancement layer data, and further comprising instructions that cause the processor to decode, separately from the first enhancement layer data, second enhancement layer data for exactly one of the left view and right view not associated with the first enhancement layer data, wherein the second enhancement layer has the first resolution, and wherein decoding the second enhancement layer data comprises decoding the enhancement layer data relative to at least a portion of the base layer data or at least a portion of first enhancement layer data

20. A method of encoding video data comprising base layer data and enhancement layer data, the method comprising:
encoding base layer data having a first resolution, wherein the base layer data comprises a reduced resolution version of a left view relative to the first resolution and a reduced resolution version of a right view relative to the first resolution; and
encoding enhancement layer data having a first resolution and comprising enhancement data for exactly one of the left view and the right view, wherein the enhancement data has the first resolution, and wherein decoding the enhancement layer data comprises decoding the enhancement layer data relative to at least a portion of the base layer data.

21. The method of claim 20, wherein the enhancement layer data comprises first enhancement layer data, the method further comprising encoding, separately from the first enhancement layer data, second enhancement layer data for exactly one of the left view and right view not associated with the first enhancement layer data, wherein the second enhancement layer has the first resolution, and wherein encoding the second enhancement layer data comprises encoding the second enhancement layer data relative to at least a portion of the base layer data or at least a portion of first enhancement layer data.

22. The method of claim 21, wherein encoding the second enhancement layer data comprises inter-layer predicting the second enhancement layer data from an upsampled version of the view of the base layer data corresponding to the second enhancement layer, wherein the upsampled version has the first resolution.

23. The method of claim 21, wherein encoding the second enhancement layer data comprises inter-view predicting the second enhancement layer data from at least one of an upsampled version of the other view of the base layer having the first resolution and the first enhancement layer data.

24. The method of claim 21, further comprising providing information indicative of whether inter-layer prediction is enabled and whether inter-view prediction is enabled for at least one of the first enhancement layer data and the second enhancement layer data.

25. The method of claim 21, further comprising providing information indicative of operation points of a representation comprising the base layer, the first enhancement layer, and the second enhancement layer, wherein the information indicative of the operation points indicates layers included in each of the operation points, a maximum temporal identifier representative of a maximum frame rate for the operation points, profile indicators representative of video coding profiles to which the operation points conform, level indicators representative of levels of the video coding profiles to which the operation points conform, and average frame rates for the operation points.

26. The method of claim 21, further comprising encoding reference picture list construction data located in a slice header associated with the second enhancement layer that indicates whether the prediction data is associated with the upsampled version of the other view of the base layer having the first resolution or the first enhancement layer data.

27. The method of claim 20, wherein encoding the enhancement layer data comprises inter-layer predicting the enhancement layer data from an upsampled version of a corresponding left view or right view of the base layer data, wherein the upsampled version has the first resolution.

28. The method of claim 20, wherein encoding the enhancement layer data comprises inter-view predicting the enhancement layer data from an upsampled version of an opposite view of a corresponding left view or right view of the base layer data, wherein the upsampled version has the first resolution.

29. An apparatus for encoding video data comprising a left view of a scene and a right view of the scene, wherein the left view has a first resolution and the right view has the first resolution, the apparatus comprising a video encoder configured to encode base layer data comprising a reduced resolution version of the left view relative to the first resolution and the reduced resolution version of the right view relative to the first resolution, encode enhancement layer data comprising enhancement data for exactly one of the left view and the right view, wherein the enhancement data has the first resolution, and output the base layer data and the enhancement layer data.

30. The apparatus of claim 29, wherein the enhancement layer data comprises first enhancement layer data, and the video encoder is further configured to encode, separately from the first enhancement layer data, second enhancement layer data for exactly one of the left view and right view not associated with the first enhancement layer data, wherein the second enhancement layer has the first resolution, and wherein encoding the second enhancement layer data comprises encoding the second enhancement layer data relative to at least a portion of the base layer data or at least a portion of first enhancement layer data.

31. The apparatus of claim 30, wherein encoding the second enhancement layer data comprises inter-layer predicting the second enhancement layer data from an upsampled version of the view of the base layer data corresponding to the second enhancement layer, wherein the upsampled version has the first resolution.

32. The apparatus of claim 30, wherein encoding the second enhancement layer data comprises inter-view predicting the second enhancement layer data from at least one of an upsampled version of the other view of the base layer having the first resolution and the first enhancement layer data.

33. The apparatus of claim 30, wherein the video encoder is further configured to provide information indicative of whether inter-layer prediction is enabled and whether inter-view prediction is enabled for at least one of the first enhancement layer data and the second enhancement layer data.

34. The apparatus of claim 30, wherein the video encoder is further configured to provide information indicative of operation points of a representation comprising the base layer, the first enhancement layer, and the second enhancement layer, wherein the information indicative of the operation points indicates layers included in each of the operation points, a maximum temporal identifier representative of a maximum frame rate for the operation points, profile indicators representative of video coding profiles to which the operation points conform, level indicators representative of levels of the video coding profiles to which the operation points conform, and average frame rates for the operation points.

35. The apparatus of claim 30, wherein the video encoder is further configured to encode reference picture list construction data located in a slice header associated with the second enhancement layer that indicates whether the prediction data is associated with the upsampled version of the other view of the base layer having the first resolution or the first enhancement layer data.

36. The apparatus of claim 29, wherein encoding the enhancement layer data comprises inter-layer predicting the enhancement layer data from an upsampled version of a corresponding left view or right view of the base layer data, wherein the upsampled version has the first resolution.

37. The apparatus of claim 29, wherein encoding the enhancement layer data comprises inter-view predicting the enhancement layer data from an upsampled version of an opposite view of a corresponding left view or right view of the base layer data, wherein the upsampled version has the first resolution

38. The apparatus of claim 29, wherein the apparatus comprises at least one of:
an integrated circuit;
a microprocessor; and
a wireless communication device that includes the video encoder.

39. An apparatus for encoding video data comprising a left view of a scene and a right view of the scene, wherein the left view has a first resolution and the right view has the first resolution, the apparatus comprising:
means for encoding base layer data comprising a reduced resolution version of the left view relative to the first resolution and the reduced resolution version of the right view relative to the first resolution;
means for encoding enhancement layer data comprising enhancement data for exactly one of the left view and the right view, wherein the enhancement data has the first resolution; and
means for outputting the base layer data and the enhancement layer data.

40. The apparatus of claim 39, wherein the enhancement layer data comprises first enhancement layer data, and the apparatus further comprises means for encoding, separately from the first enhancement layer data, second enhancement layer data for exactly one of the left view and right view not associated with the first enhancement layer data, wherein the second enhancement layer has the first resolution, and wherein encoding the second enhancement layer data comprises encoding the second enhancement layer data relative to at least a portion of the base layer data or at least a portion of first enhancement layer data.

41. A computer program product comprising a computer-readable storage medium having stored thereon instructions that, when executed, cause a processor of a device for encoding video data to:
receive video data comprising a left view of a scene and a right view of the scene, wherein the left view has a first resolution and the right view has the first resolution;
encode base layer data comprising a reduced resolution version of the left view relative to the first resolution and the reduced resolution version of the right view relative to the first resolution;
encode enhancement layer data comprising enhancement data for exactly one of the left view and the right view, wherein the enhancement data has the first resolution; and
output the base layer data and the enhancement layer data.

42. The computer program product of claim 41, wherein the enhancement layer data comprises first enhancement layer data, and further comprising instructions that, when executed, cause a processor of a device for encoding video data to encode, separately from the first enhancement layer data, second enhancement layer data for exactly one of the left view and right view not associated with the first enhancement layer data, wherein the second enhancement layer has the first resolution, and wherein encoding the second enhancement layer data comprises encoding the second enhancement layer data relative to at least a portion of the base layer data or at least a portion of first enhancement layer data.
